(19) United States
(12) Patent Application Publication
(10) Pub. No.: US 2015/0350986 A1
(43) Pub. Date: Dec. 3, 2015

(54) Method and Apparatus for Soft Handover Guidance in WCDMA TD Scheduling

(71) Applicant: TELEFONAKTIEBOLAGET L M ERICSSON (PUBL), Stockholm (SE)

(72) Inventors: Torbjörn WIGREN, UPPSALA (SE); Billy HOGAN, SOLLENTUNA (SE); Nianshan SHI, JÄRFÄLLA (SE)

(21) Appl. No.: 14/759,680

(22) PCT Filed: Jan. 15, 2013
(86) PCT No.: PCT/SE2013/050020

§ 371 Date: Jul. 8, 2015

(51) Int. Cl. H04W 36/18; H04W 72/14; H04W 72/12

(52) U.S. Cl. CPC H04W 36/18; H04W 72/1231; H04W 72/14

(57) ABSTRACT

A method and NodeB for assisting, in a first NodeB, in soft handover procedures in WCDMA time division schedules comprises estimating (210) of a high bandwidth neighbour cell interference power for each time division slot. A first change trend of the estimated high bandwidth neighbour cell interference power is computed (212) for each of the time division slots. A future incoming soft handover event of a UE from a neighbour NodeB to the first NodeB, and a future incoming soft handover time for the future incoming soft handover event, is predicted (220). This prediction is based on the first change trend of the estimated high bandwidth neighbour cell interference power. Scheduling of time division slots of UEs is adapted (230) before the predicted future incoming soft handover time. This adaptation is configured to create interference power headroom for the predicted future incoming soft handover event.

### TECHNICAL FIELD

The present embodiments refer in general to soft/softer handover routines in cellular communication networks and in particular to devices and methods for supporting soft/softer handover in time division scheduling in wideband code division multiple access systems.

### BACKGROUND

As is well known in prior art and as discussed in many textbooks, Wideband Code Division Multiple Access (WCDMA) supports soft and softer handover.

Softer handover essentially means that User Equipments (UEs) are simultaneously connected and synchronized to more than one cell of a Radio Base Station (RBS). This provides extra signal power, so-called macro diversity gain, and provides a soft transition between cells when the UE migrates over the cell boundary region. Since the cells are in the same RBS, softer combining of powers between cells can be used, which may give a substantial performance boost.

When the cells are not in the same RBS, softer combining cannot be used. Instead, when the cells are in soft handover, prior art technology typically signals the received information to the Radio Network Controller (RNC) which chooses the most beneficial RBS to represent the received signal from the UE.

Soft and softer handover are functions at the core of WCDMA. In softer handover between cells of the same RBS, transmissions between the UE and each cell can be softly combined. In soft handover between cells in different RBSs, a hard decision between the radio links of the different cells is made instead. The decision to initiate a soft(er) handover is governed by certain events that compare e.g. estimated signal to interference ratios to thresholds. Standard signal processing tools like hysteresis is used to avoid chattering.

Scheduling of traffic in the WCDMA Enhanced UpLink (EUL) is performed according to the water-filling principle. This means that user traffic is scheduled in order to make use of the available interference headroom. This interference headroom is typically measured in terms of the rise over thermal.

This basic setting accounts for the experienced interference level in the own cell. In HetNet environments it becomes important to take a more careful approach, avoiding interference impact to the largest possible extent on neighbouring cells. This has at least two benefits. First, it is likely to enhance the capacity of the WCDMA cellular system significantly. Secondly, it would simplify management by reducing the cross coupling between cells.

Now, accounting for neighbour cell interference created by own scheduling decisions requires accurate knowledge of coupling factors, showing how own scheduled UL power appear as neighbour cell interference in adjacent cells. However, estimation of such coupling factors is not fully understood in prior art.

In the 3GPP release 99, the RNC controls resources and user mobility. Resource control in this framework means admission control, congestion control, channel switching, i.e. roughly changing the data rate of a connection. Furthermore, a dedicated connection is carried over a Dedicated Channel (DCH), which is realized as a Dedicated Physical Control Channel (DPCCH) and a Dedicated Physical Data Channel (DPDCH).

In the evolved 3G standards, the trend is to decentralize decision making, and in particular the control over the short term data rate of the user connection. The uplink data is then allocated to an Enhanced Dedicated Channel (E-DCH), which is realized as the triplet: a DPCCH, which is continuous, an Enhanced Dedicated Physical Control Channel (E-DPCCH) for data control and an Enhanced Dedicated Physical Data Channel (E-DPDCH) for data. The two latter are only transmitted when there is uplink data to send. Hence the NodeB uplink scheduler determines which transport formats each user can use over E-DPDCH. The RNC is however still responsible for admission control.

A data block is sent by the UE to the NodeB during a Transmission Time Interval (TTI). For efficiency reasons, the received data blocks at the receiver are processed in parallel at M parallel processors taking turn to process data. While data block i is processed and decoding information is fed back to the transmitter, the receiver starts processing data blocks i, i+1, . . . etc. By the time the first receiver processor has decoded the data block and fed back the decoding result, it is ready for processing either a retransmission of information related to the recently processed data or a new data block. By combining information both from the original data block and the retransmission, it is possible to correct errors in the reception. A retransmission scheme with both error correction and error detection is referred to Hybrid Automatic Repeat-reQuest (HARQ). Therefore, the M processors are often referred to as HARQ processes, each handling a data block received in a TTI.

In the WCDMA uplink, there is a trade-off between coverage and enabled peak rates. This is even more emphasized with enhanced uplink, which supports higher bit rates than ordinary dedicated channels. The uplink resources are limited by the Rise over Thermal (RoT) that the cell can tolerate. The RoT limit is either motivated by coverage requirements or power control stability requirements. When only one user is connected in the cell, both power control stability and coverage are minor issues, since the uplink interference is likely to be dominated by the power generated by this user. In such a case it is tempting to allow a high RoT in order to allow high received signal relative interference powers, Ec/Io, which enables the use of high uplink bit rates. Conversely, in order to use the high uplink bit rates, the user connections have to provide high Ec/Io, which implies high RoT.

Recently mobile broadband traffic has been increasing dramatically in WCDMA networks. The technical consequence is a corresponding steep increase of the interference in these networks, or equivalently, a steep increase of the load. This makes it important to exploit the load headroom that is left in the most efficient way. To do so, a so called Time Division (TD) scheduling has been introduced in the WCDMA uplink. This implements a scheme where 8 consecutive 2 ms slots, each with its own HARQ process, provide time division and orthogonality between users. TD scheduling is expected to expand the uplink capacity significantly, in particular in the future when more than one uplink high rate user may be scheduled in each TD slot, thereby enabling interference suppression and interference cancellation receivers to boost capacity.

Thus, in order to orthogonalize the uplink user transmissions to a greater extend, it can be relevant to separate the user data transmissions in time, and employ a Time Division Multiplexing (TDM) scheme. It is possible to allocate grants to a user that is only valid for specified HARQ processes. This fact can be exploited to enable TDM for EUL. Furthermore, it allows retransmissions without interfering with other users, since retransmissions hit the same HARQ process as the original transmission.

However, the introduction of TD scheduling in WCDMA also gives rise to certain difficulties. Now, HARQ processes and TD scheduling are controlled solely by the NodeB. Therefore, there is yet no standardised or even proprietary procedure for soft handover, as it is for R99 users. A particular inconvenience is the fact that the TTI instances may not be synchronized between RBSs. Now, for instance, there is no TD signalling in prior art that supports scheduler coordination between different NodeBs. In particular, lack of signalling in support of soft handover information between NodeBs means that the NodeBs are ignorant of other NodeBs scheduling decisions. Therefore in case soft handover would be used, the soft handover has to be blind, i.e. without knowledge of the counterpart situation. This ignorance, in particular regarding potential soft handovers, implies a significant risk of high rate users in neighbour NodeBs being allocated to the same TD slot, in the un-synchronized case unknown which slot. This may result in interference peaks and instabilities in the uplink in case a new soft handover leg would be added in the neighbour NodeB. Such effects must be avoided, or the effects of them at least mitigated. The result is a loss of macro diversity gain.

Note also that such phenomena in one TD slot in the uplink may couple to adjacent slots since the automatic gain control circuitry may not be able to follow the rapid interference changes. That would make the problem even worse.

### SUMMARY

An object of the present embodiments is to provide more reliable soft handover in WCDMA systems employing TD scheduling. The object is achieved by methods and devices according to the enclosed independent claims. Particular preferred embodiments are defined in the dependent claims. In general words, in a first aspect, a method for assisting soft handover procedures in WCDMA time division schedules comprises estimating, in a first NodeB, of a high bandwidth neighbour cell interference power for each time division slot. A first change trend of the estimated high bandwidth neighbour cell interference power is computed in the first NodeB for each of the time division slots. A future incoming soft handover event of a UE from a neighbour NodeB to the first NodeB, and a future incoming soft handover time for the future incoming soft handover event, is predicted in the first NodeB. This prediction is based on the first change trend of the estimated high bandwidth neighbour cell interference power. Scheduling of time division slots of UEs is adapted in the first NodeB before the predicted future incoming soft handover time. This adaptation is configured to create interference power headroom for the predicted future incoming soft handover event.

In a second aspect, a NodeB in a WCDMA communication system comprises a scheduler for WCDMA time division, an interference estimator, a trend follower and a predictor. The interference estimator is configured to estimate a high bandwidth neighbour cell interference power for each time division slot. The trend follower is connected to the interference estimator. The trend follower is configured for computing a first change trend of the estimated high bandwidth neighbour cell interference power for each of the time division slots. The predictor is connected to the trend follower. The predictor is configured for predicting a future incoming soft handover event of a UE from a neighbour NodeB to the first NodeB. The predictor is also configured for predicting a future incoming soft handover time for the future incoming soft handover event. These predictions are performed based on the first change trend of the estimated high bandwidth neighbour cell interference power. The scheduler is connected to the predictor. The scheduler is configured for adapting the scheduling of time division slots before the predicted future incoming soft handover time. The adapting is configured to create interference power headroom for the predicted future incoming soft handover event.

The present embodiments thus provides methods and node means to obtain guidance that indicates that a neighbour mobile may be in a situation where a soft handover would be immediate, or that an own user may interfere significantly with respect to certain neighbour cell(s), also indicating that a soft handover, would be immediate. The disclosed embodiments also provide methods and node means to prepare for such a soft handover. The approach for guidance utilizes estimates of neighbour cell interference in each cell and TD slot, and in particular embodiments also impact factors of own scheduling decisions on TD slots in specific neighbour cells. The embodiments disclose methods and node means for mitigation of soft handover collision risks, when blind algorithms are used for this purpose.

One main advantage of the embodiments includes mitigation of soft handover collision problems, occurring due to insignificant signalling between NodeBs. This is a step in order to facilitate the introduction of soft handover for TD scheduling, an approach that in turn enhances performance due to the resulting macro diversity gain. As a result uplink capacity and coverage are expected to benefit.

### BRIEF DESCRIPTION OF THE DRAWINGS

The invention, together with further objects and advantages thereof, may best be understood by making reference to the following description taken together with the accompanying drawings, in which:

FIG. 1 is a schematic illustration of a WCDMA system;

FIG. 2 is a schematic illustration of parallel HARQ processes;

FIG. 3 is a schematic illustration of an example of user scheduling in time division multiplex;

FIG. 4 is a flow diagram of steps of an embodiment of a method for assisting in soft handover;

FIG. 5 is an embodiment of estimated neighbour cell interference in a TD structure;

FIG. 6 is an embodiment of estimated neighbour cell interference in a TD structure with time evolution, filtering and prediction;

FIG. 7 is a flow diagram of steps of an embodiment of a part method for predicting incoming soft handover events and time thereof;

FIG. 8 is a diagram illustrating an embodiment of a prediction strategy;

FIG. 9 is a flow diagram of steps of an embodiment of a part method for adapting scheduling of time division slots;

FIG. 10 is a block scheme of an embodiment of a NodeB;

FIG. 11 is a block scheme of an embodiment of an implementation of a NodeB;

FIG. 12 is an illustration of one embodiment for signalling of neighbour cell interference power estimates, obtained in neighbour cells;

FIG. 13 is an embodiment of estimated neighbour cell interference in a neighbour cell;

FIG. 14 is an embodiment of estimated neighbour cell interference in a neighbour cell with time evolution, filtering and prediction;

FIG. 15 is a flow diagram of steps of another embodiment of a method for assisting in soft handover;

FIG. 16 is a flow diagram of steps of an embodiment of a part method for predicting outgoing soft handover events and time thereof;

FIG. 17 is a diagram illustrating an embodiment of a prediction strategy;

FIG. 18 is a flow diagram of steps of another embodiment of a part method for adapting scheduling of time division slots;

FIG. 19 is a block scheme of another embodiment of a NodeB;

FIG. 20 is a block scheme of another embodiment of an implementation of a NodeB;

FIG. 21 is an illustration of transmission of enhanced relative grants over E-RGCH;

FIG. 22 is an illustration of signalling of a handover prediction indicator and associated time; and

FIG. 23 is a diagram showing RMS inaccuracy of the neighbour cell interference estimate as a function of the neighbour cell interference power level.

### DETAILED DESCRIPTION

Throughout the drawings, the same reference numbers are used for similar or corresponding elements.

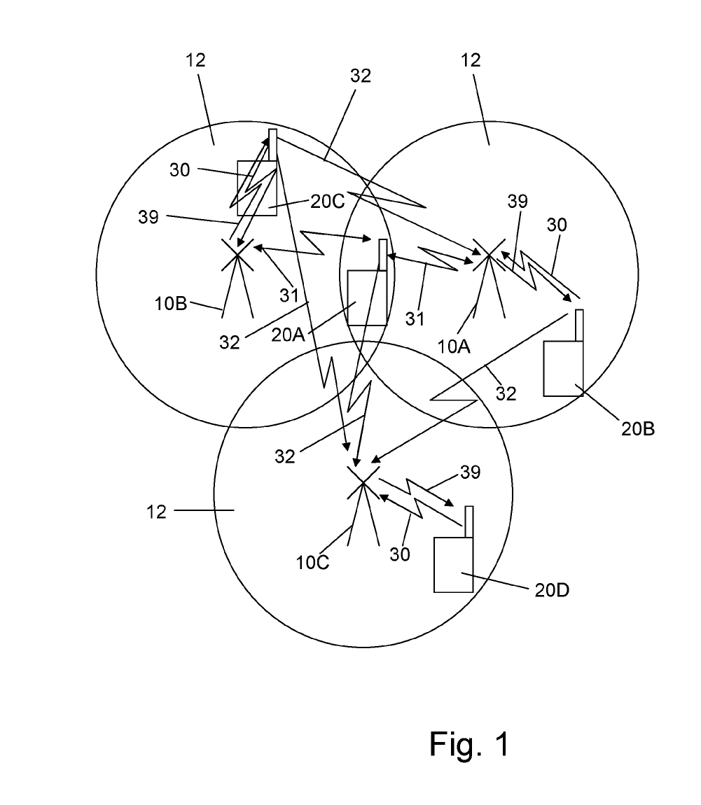

FIG. 1 schematically illustrates a WCDMA system 1. A number of NodeBs 10A-C each has its own cell 12. A number of UEs 20A-D are present within the coverage of the cells 12. The UEs 20A-D communicate with uplink signals 30 with a respective NodeB 10A-C of the cell in which it is situated. The NodeBs 10A-C communicate with the UEs 20A-D within their respective cell 12 with downlink signals 39. A UE, e.g. UE 20B connected to NodeB 10A, will also provide interfering uplink signals 32 to neighbour NodeBs, e.g. NodeB 10C or NodeB 10B. Such interference will depend on the transmission power of the UE as well as the position of the UE relative the NodeB it interferes with. For a UE transmitting with a constant power, the interference experienced in a neighbour NodeB will present a general increasing trend when the UE moves closer to the neighbouring NodeB.

When a UE, e.g. UE 20A, becomes located close enough to the border between two cells, a soft handover between the neighbouring NodeBs 10A and 10B is typically performed, involving soft handover signalling 31.

In the present disclosure, it is assumed that a blind soft handover scheme is provided in the WCDMA system, according to prior art knowledge. The details of such a soft handover scheme, and the associated signalling 31, do not as such have any impact on the ideas discussed further below and are therefore beyond the scope of the embodiments presented below. Such details are therefore not further discussed.

It can be noted that there are more impact factors than neighbour cell interference estimates available in a NodeB at a certain point in time. Hence it should be clear that in order to compute estimates also of impact or coupling factors, it is needed to provide additional information in some impact or coupling factor computing node, e.g. in a NodeB, RNC or other connected node. Such additional information preferably comprises an estimate of the experienced neighbour cell interference power in a specific cell, for a sequence of time instances. The additional information preferably also comprises estimates of the own cell interference estimated in surrounding cells and/or NodeBs, i.e. interference transmitted from surrounding cells, for the same sequence of time instances.

Preferably, such information is signalled continuously. Given such interference information, algorithms for impact factor calculation are available in prior art for the Long Term Evolution (LTE) radio access network, see e.g. the published International patent application WO 2009/019074. However, such algorithms do not account for soft/softer handover interference power since these concepts do not exist in LTE. Furthermore, algorithms for accurate high bandwidth neighbour cell interference estimation are not known in prior art for WCDMA either, and this is a pre-requisite for coupling factor estimation.

In order to have a stable and reliable handover process, the scheduler preferably has predicting capabilities. What is preferably needed in the scheduler is the ability to predict how a scheduling decision and an associated interference will impact on neighbour cells. However, such algorithms for neighbour cell interference/coupling factor estimation that can operate with a bandwidth close to the TD scheduling slot rate are not available in prior art, at least not at the same time that a sufficient accuracy is retained. Note that this is not the same as a simple estimate of the neighbour cell interference experienced in a certain cell.

In addition, there are no prior art algorithms that, based on estimated neighbour cell interference and/or coupling factors onto neighbour cells, provide guidance for TD soft handover, thereby mitigating the collision problem.

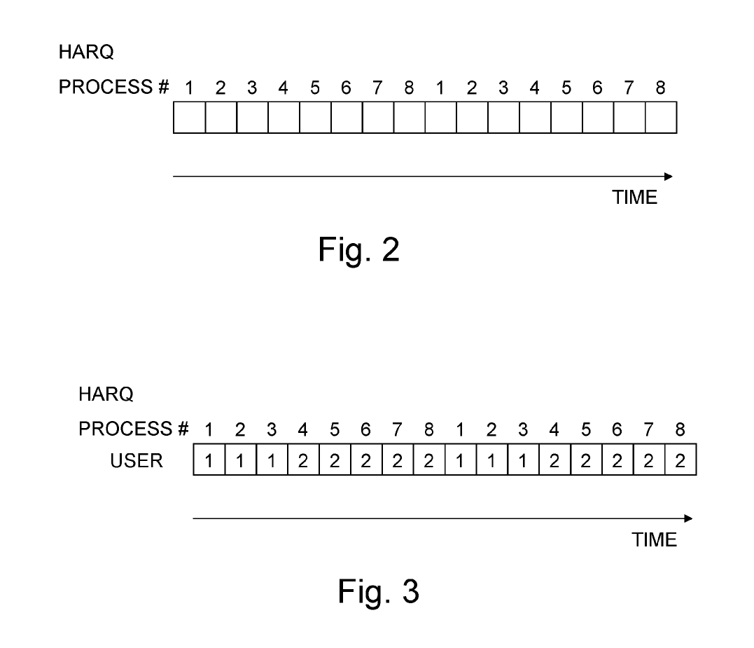

As mentioned earlier, TD scheduling has been introduced in the WCDMA uplink. FIG. 2 illustrates a scheme where 8 consecutive 2 ms slots, each with its own HARQ process, provide time division between signals. The signalling in one HARQ process does not in any significant degree influence the signalling in any of the other HARQ processes.

In FIG. 3, a TDM scheme is illustrated, where two users share the resource by being separated in time. User 1 has access to HARQ processes 1-3, while user 2 has access to HARQ processes 4-8. This is repeated in consecutive TTIs. Such an arrangement thus provides orthogonality between the users.

The orthogonality between the users also opens up for at least partly distinguishing interference effects from different users. When a UE comes closer to a cell border, the interference experienced by the neighbouring NodeB will increase. When the signal strength between the UE and the neighbour NodeB becomes strong enough a soft handover is likely to occur. Therefore, if, in a certain NodeB, the neighbour interference of a certain HARQ process has a relatively strong increasing trend, it is likely that a UE is closing up to the cell border of the NodeB, which in turn means that a soft handover is likely to be performed. By extrapolating such an increasing trend into the future, it will also be possible to estimate the time at which a soft handover is likely to occur.

The NodeB has no information about which particular UE that is coming closer. Furthermore, since the NodeBs in WCDMA are not perfectly synchronized, it is not possible to determine in what HARQ process of the NodeB, to which the UE presently is connected, the UE utilizes. However, the neighbour NodeB can anyway perform preparations for a soft handover by adapting its own scheduling for making interference peaks and instabilities less likely. For instance, load headroom can be released for preparing to accept a new UE to be connected.

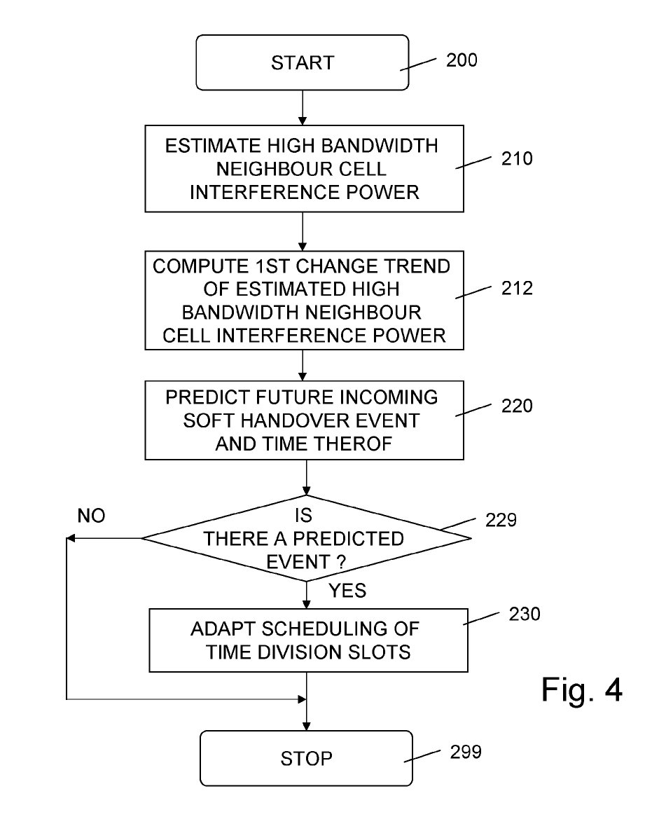

FIG. 4 illustrates a flow diagram of steps of an embodiment of a method for assisting in soft handover procedures in WCDMA time division schedules. The method starts in step 200. In step 210, a high bandwidth neighbour cell interference power is estimated, in a first NodeB. This estimation is performed for each time division slot of the WCDMA time division schedule. The details of preferred estimation algorithms are discussed further below. In step 212, still performed in the first NodeB, a first change trend of the estimated high bandwidth neighbour cell interference power is computed. This is also performed separately for each of the time division slots. In step 220, it is predicted if a future incoming soft handover event of a UE from a neighbour NodeB to the first NodeB is likely to occur. The prediction also comprises a future incoming soft handover time for the future incoming soft handover event, if any. This prediction is also performed in the first NodeB. The prediction is based on the first change trend of the estimated high bandwidth neighbour cell interference power. The step thus predicts ahead in time that a soft handover event is likely to occur. If a future incoming soft handover event is predicted, as decided in step 229, an adaptation step 230 is performed, otherwise the process ends in step 299. In step 230 scheduling of time division slots of UEs is adapted in the first NodeB. The adaptation is performed before the predicted future incoming soft handover time. The adaptation is configured for creating interference power headroom for the predicted future incoming soft handover event. The process ends in step 299.

Measurement and estimation techniques, as such, needed to measure the instantaneous total load on the uplink air interface are known in prior art. It is e.g. shown in prior art that the load at the antenna connector is given by the noise rise, or rise over thermal, RoT(t), defined by:

$$RoT ( t ) = \frac{{P}_{RTWP} ( t )}{{P}_{N} ( t )} , \qquad ( 1 )$$

where P_{N}(t) is the thermal noise level as measured at the antenna connector. It remains to define what is meant with P_{RTWP}(t). This relative measure is unaffected by any de-spreading applied. The definition used here is simply the total wideband power:

$${P}_{RTWP} ( t ) = {\sum }_{i = 1}^{I} {P}_{i} ( t ) + {P}_{neighbor} ( t ) + {P}_{N} ( t ) , \qquad ( 2 )$$

also measured at the antenna connector. Here P_{neighbor}(t) denotes the power as received from neighbour cells of the WCDMA system, while Pᵢ(t) denotes the power of user i in the own cell.

The major difficulty of any RoT estimation algorithm is to separate the thermal noise power from the interference from neighbour cells. Such problems are discussed e.g. in “Estimation of uplink WCDMA load in a single RBS”, by T. Wigren and P. Hellqvist, Proc. IEEE VTC-2007 Fall, Baltimore, Md., USA, Oct. 1-3, 2007, in “Soft uplink load estimation in WCDMA”, by T. Wigren, IEEE Trans Veh. Tech., March, 2009, in the published International Patent Application WO 2006/076969, in the published International Patent Application WO 2007/024166, or in the published International Patent Application WO 2007/055626. Recursive algorithms are presented e.g. in “Recursive noise floor estimation in WCDMA”, by T. Wigren, IEEE Trans. Veh. Tech., vol. 59, no. 5, pp. 2615-2620, 2010, or in the published International Patent Application WO 2008/039123.

For the purpose of the present disclosure, an estimator for high bandwidth neighbour cell interference power estimation is implemented for each HARQ process. One particular embodiment of such an estimator is described in the Appendix A. One feature of such an estimator is that the step of estimating comprises obtaining of process measurements of a received total wideband power received in the first NodeB. Furthermore, process measurements of the uplink load utilization are obtained. Based on this, a joint estimate of at least the sum of the neighbour cell interference power and a noise floor power is performed. In one particular embodiment, the step of estimating comprises performing of a joint estimate of the neighbour cell interference power and of the noise floor power. In a preferred embodiment, the step of estimating is performed by either Bayesian estimation algorithms or extended Kalman filtering in combination with a thermal noise power estimation scheme.

However, in alternative embodiments, other high bandwidth neighbour cell interference power estimation principles can be used as well.

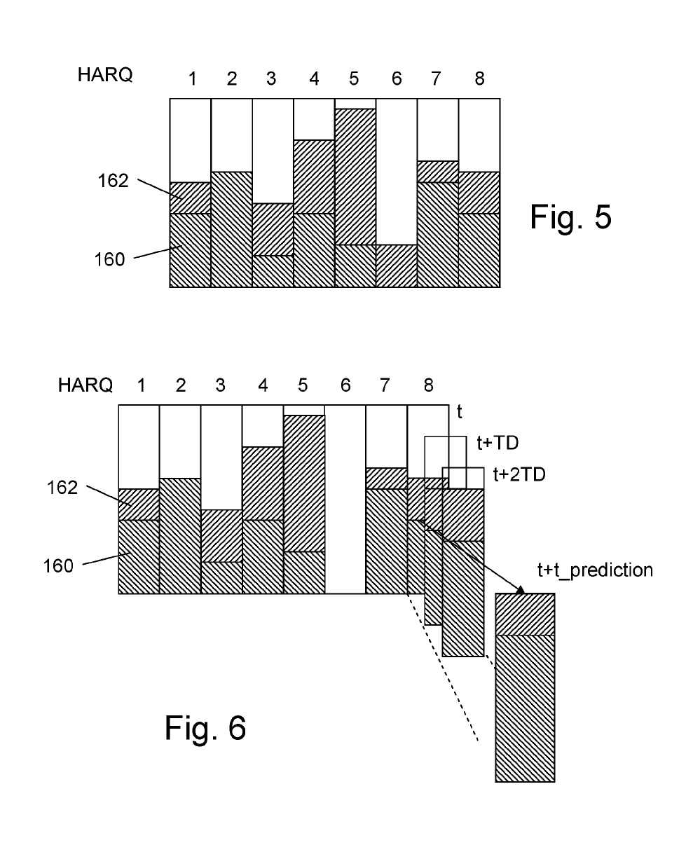

In a system having 8 TD slots of 2 ms each, there are hence 8 such estimators. Each estimator provides a high bandwidth estimate of the neighbour cell interference power experienced in the uplink of the cell, in the specific TD slot. As explained above, the other interference power components comprise the own cell interference power and the thermal noise power. The situation is depicted in FIG. 5, where the estimated neighbour cell interference is denoted by 160 and the estimated own cell interference is denoted by 162. Note that thermal noise is not shown.

Now, every 16:th millisecond such an estimate is available in each TD slot. By appropriate filtering, it is possible to estimate the current level of the neighbour cell interference power. This can in one embodiment be performed e.g. using a Kalman filter based on a trend model. In such an embodiment, the rate of change of the neighbour cell interference power can be provided together with the current level estimate. A trend model suitable for this purpose is straightforward to write in state space form as:

$$\begin{matrix}( \begin{matrix}{x}_{neighbor} ( t + {T}_{TD} ) \\ {neighbor}_{} ( t + {T}_{TD} )\end{matrix} ) = ( \begin{matrix}1 & {T}_{TD} \\ 0 & 1\end{matrix} ) ( \begin{matrix}{x}_{neighbor} ( t ) \\ {neighbor}_{} ( t )\end{matrix} ) + ( \begin{matrix}{w}_{neighbor} ( t ) \\ {neighbor}_{} ( t )\end{matrix} ) & ( 3 ) \\ {P}_{neighbor} ( t ) = \begin{matrix}( 1 & 0 )\end{matrix} ( \begin{matrix}{x}_{neighbor} ( t ) \\ {neighbor}_{} ( t )\end{matrix} ) + {e}_{neighbor} ( t ) . & ( 4 )\end{matrix}$$

Here (x_{neighbor}(t) & x_{neighbor}(t))^{T} denotes the state vector, with the second component representing the rate of change state variable. Further, T_{TD} denotes the time between TD slot activity. The vector (w_{neighbor}(t) & w_{neighbor}(t))^{T} denotes the systems noise, P_{neighbor}(t) denotes the estimated neighbour cell interference power, and e_{neighbor}(t) denotes the neighbour cell interference power estimation error. Together with statistical assumptions on the covariances of the errors as given by:

$$\begin{matrix}{R}_{1 , neighbor} = E [ \begin{matrix}( {w}_{neighbor} ( t ) & {neighbor}_{} ( t ) ) ( \begin{matrix}{w}_{neighbor} ( t ) \\ {neighbor}_{} ( t )\end{matrix} )\end{matrix} ] & ( 5 ) \\ {R}_{2} = E ⌊ {e}_{neighbor}^{2} ( t ) ⌋ , & ( 6 )\end{matrix}$$

all information is available for application of the Kalman filter of Equation (A17) of Appendix A.

Given the estimate neighbor (\hat{x}_{neighbor}(t|t) & \hat{x}_{neighbor}(t|t))^{T}, it becomes possible to predict ahead in time, using:

\hat{x}(t+t_{prediction})=\hat{x}(t|t)+t_{prediction}&\hat{x}(t|t). (7)

A possible outcome of the filtering and prediction is illustrated in FIG. 6. The time evolution, filtering and prediction of neighbour cell interference for one HARQ process is illustrated. One can notice that in this particular example, the contribution from the neighbour cell interference increases with time. Given this prediction it can be investigated if the value is of such a character that an incoming soft handover is likely after the predicted time. If it is, then preparatory actions can be taken by the scheduler, in order to avoid excessive RoT values in the TD slot. This is further discussed below.

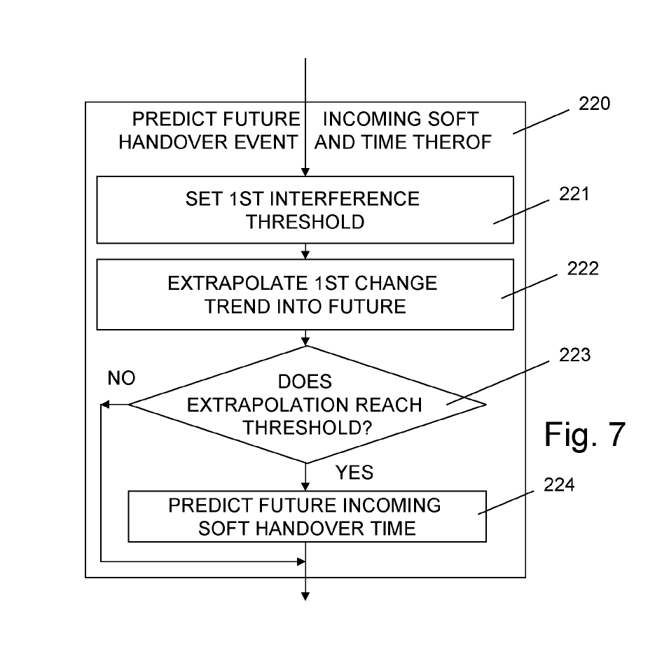

In a particular embodiment, as illustrated in FIG. 7, the step 220 of predicting comprises the use of a threshold. In step 221, a first interference threshold is set. In step 222, the first change trend is extrapolated into the future. In step 223, it is decided if the extrapolated first change trend reaches the first interference threshold. If the extrapolated first change trend reaches the first interference threshold the future incoming soft handover event is predicted to occur. Otherwise, no prediction is made. If a prediction is made, the future incoming soft handover time is predicted in step 224 as the time at which the extrapolated first change trend reaches the first interference threshold.

In an alternative embodiment, step 222 can be performed before step 221. In a further alternative embodiment, steps 221 and 222 can be performed at least partly simultaneously or intermittently.

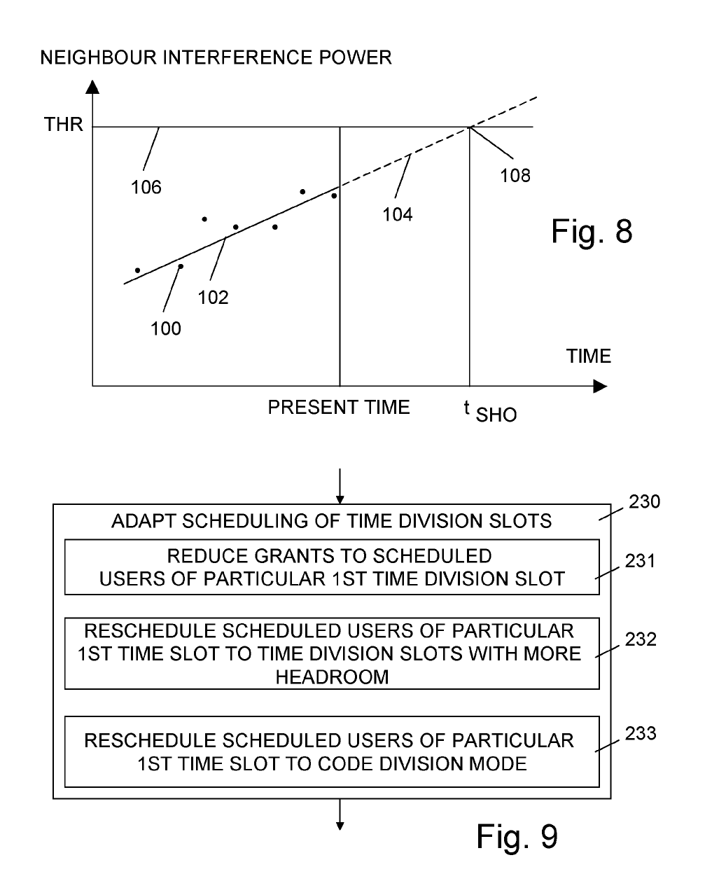

This embodiment can be further understood by referring to FIG. 8, illustrating a diagram of estimated high bandwidth neighbour cell interference powers 100 for a particular TD slot as a function of time. The computed first change trend of the estimated high bandwidth neighbour cell interference power is illustrated by the full line 102. The change trend is extrapolated into the future, i.e. ahead of a present time, as illustrated by the broken line 104. The first interference threshold is illustrated as the line 106. In the present example, the extrapolated first change trend 104 reaches the first interference threshold 106 at the point 108, and this gives rise to a prediction of a future incoming soft handover event to occur. The future incoming soft handover time t_{SHO} is predicted as the time of the point 108.

As mentioned above, increasing estimated interference over time in a TD slot can be an indication of an incoming soft handover. The TD scheduler may then use the prediction to find a prediction time in the future when the neighbour cell interference level is expected to reach a point so that a tentative incoming soft handover is detected. The TD scheduler can then initiate actions in order to create interference headroom for the incoming soft handover. In a particular embodiment, such actions are initiated only in case the prediction time is below a preconfigured time threshold, thus not reacting on possible event too far in the future. A similar effect can in another embodiment be achieved by utilizing a maximum future prediction time of the trend prediction.

The actions initiated by the TD scheduler preferably adapt the scheduling of the time division slots of UEs. In one embodiment, the grants to scheduled users in the particular TD slot are reduced. In another embodiment, users are re-scheduled of to other TD slots with more headroom. In yet another embodiment, users in the TD slot in question are re-scheduling to the Code Division Multiplex (CDM) mode. In further embodiments, two or more of the above suggested actions are performed together. Here, CDM is the usual WCDMA uplink mode, not subject to TD scheduling. It is noted that the filtering, prediction, and actions may be performed on a regular basis, even at the same rate as the TD-scheduling.

In a particular embodiment, as illustrated in FIG. 9, the step 230 of adapting comprises, if the predicted future incoming soft handover event is predicted to occur based on the estimated high bandwidth neighbour cell interference power in a particular first time division slot, at least one of the steps 231, 232 and 233. In step 231, grants to scheduled users of the particular first time division slot are reduced. In step 232, scheduled users of the particular first time division slot are rescheduled to time division slots with more headroom. In step 233, scheduled users of the particular first time division slot are rescheduled to code division mode. Thus, in different embodiments, the steps 231, 232 and 233 can be performed alternatively or together. The actual choice of action is preferably determined based on the actual application situation.

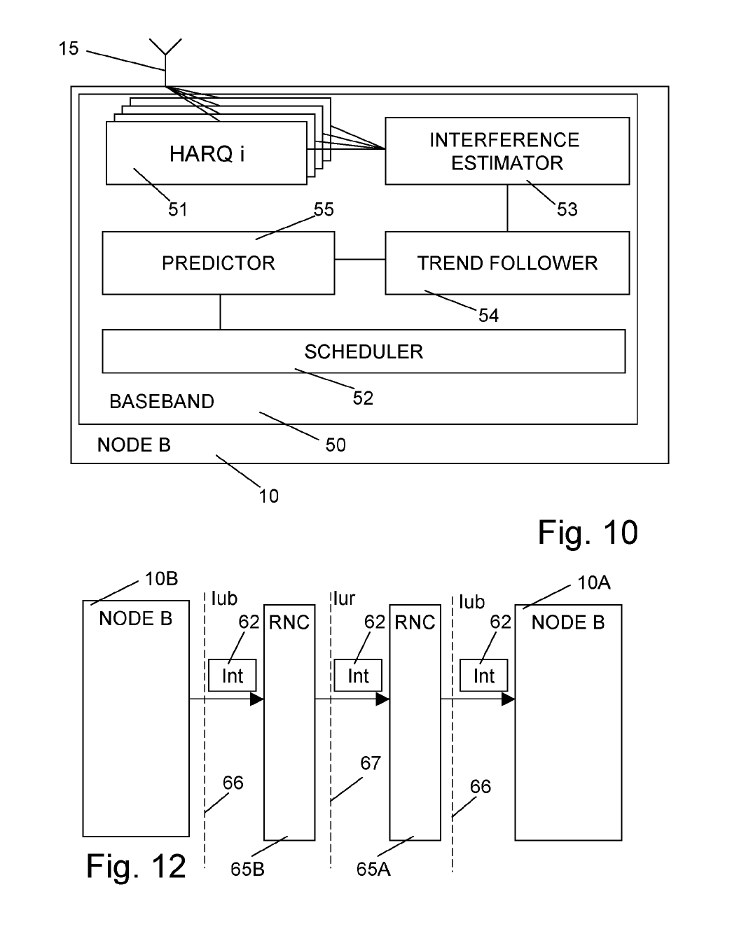

In FIG. 10, an embodiment of a NodeB 10 in a WCDMA communication system is schematically illustrated. An uplink baseband section 50 is connected to an antenna 15. The uplink baseband section 50 comprises a scheduler 52 for a WCDMA time division scheme, utilizing a number of time division slots. The antenna 15 is connected to a HARQ 51, one for each time division slot. An interference estimator 53 is connected to the HARQs 51 and configured to estimate a high bandwidth neighbour cell interference power for each time division slot. A trend follower 54 is connected to the interference estimator 53. The trend follower 54 is configured for computing a first change trend of the estimated high bandwidth neighbour cell interference power for each of the time division slots. A predictor 55 is connected to the trend follower 54. The predictor 55 is configured for predicting a future incoming soft handover event of a UE from a neighbour NodeB to the present first NodeB. The predictor 55 is also configured for predicting a future incoming soft handover time for the future incoming soft handover event, if any. The predictor 55 is configured to base its predictions on the first change trend of the estimated high bandwidth neighbour cell interference power, obtained from the trend follower 54. The scheduler 52 is connected to the predictor 55. The scheduler is configured for adapting scheduling of time division slots before the predicted future incoming soft handover time. This adaptation is performed in such a way that it results in creation of interference power headroom for the predicted future incoming soft handover event.

In one particular embodiment, the predictor is configured for setting of a first interference threshold. The predictor is further configured for extrapolating the first change trend into the future. The predictor is further configured for predicting the future incoming soft handover event to occur if the extrapolated first change trend reaches the first interference threshold. The predictor is also configured for predicting the future incoming soft handover time as the time at which the extrapolated first change trend reaches the first interference threshold.

In one particular embodiment, the predicted future incoming soft handover event is predicted to occur based on the estimated high bandwidth neighbour cell interference power in a particular first time division slot. The scheduler is then configured for reducing grants to scheduled users of the particular first time division slot, rescheduling scheduled users of the particular first time division slot to time division slots with more headroom and/or rescheduling scheduled users of the particular first time division slot to code division mode. The proposed functionalities of the scheduler can in other words be provided separately or in any combination.

In one particular embodiment, the interference estimator is configured for obtaining process measurements of a received total wideband power received in the first NodeB. The interference estimator is further configured for obtaining process measurements of the uplink load utilization. The interference estimator is also configured for performing a joint estimate of at least the sum of the neighbour cell interference power and a noise floor power. In a further particular embodiment, the interference estimator is configured for performing a joint estimate of the neighbour cell interference power and of the noise floor power, but not of the individual quantities.

In one particular embodiment, the interference estimator is configured for performing estimation by Bayesian estimation algorithms or extended Kalman filtering in combination with a thermal noise power estimation scheme.

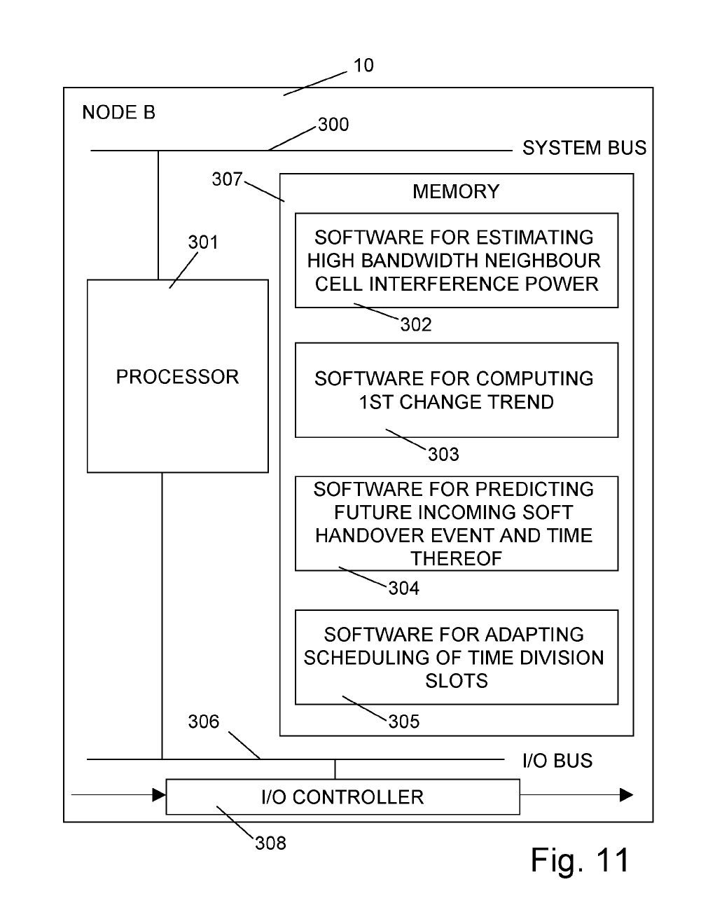

In one particular embodiment, the soft handover assisting functionalities in a NodeB are implemented by a processor by means of software. Such an implementation example, is illustrated in FIG. 11 as a block diagram. This embodiment is based on a processor 301, a memory 307, a system bus 300, an input/output (I/O) controller 308 and an I/O bus 306. In this embodiment power measurements for each HARQ are received by the I/O controller 308 and are stored in the memory 307. The I/O controller 308 also controls the issue of the scheduler actions. The processor 301, which may be implemented as one or a set of cooperating processors, executes software components stored in the memory 307 for performing the soft handover assistance activities. The processor 301 communicates with the memory 307 over the system bus 300. In particular, software component 302 may implement the functionality of estimating a high bandwidth neighbour cell interference power for each time division slot of block 53 (FIG. 10). Software component 303 may implement the functionality of computing a first change trend of the estimated high bandwidth neighbour cell interference power for each of the time division slots of block 54 (FIG. 10). Software component 304 may implement the functionality of predicting a future incoming soft handover event of a UE from a neighbour NodeB to the present first NodeB and a future incoming soft handover time for the future incoming soft handover event of block 55 (FIG. 10). Software component 305 may implement the functionality of adapting scheduling of time division slots before the predicted future incoming soft handover time of block 52 (FIG. 10).

The embodiments described above have mainly been described in connection with the idea of utilizing neighbour interference estimations in an own cell to predict incoming soft handover events. However, similar approaches can be used also on estimations of predicted impact of the uplink power from UEs of the own cell on the interference situation in a neighbour cell, and thereby predicting outgoing soft handover events.

In such embodiments, an estimator for high bandwidth neighbour cell interference power estimation is implemented for each HARQ process. One embodiment of such an estimator is described in the Appendix A. This estimator also allows for estimation of the own cell interference power.

More importantly, neighbour cell interference power estimates, obtained in neighbour cells, can be signalled to the present cell of interest. Preferably, such signalling is performed to all cells, from their neighbours. Similarly, the own controlled interference power of the UEs of each cell can be estimated. Also this information can be signalled from the neighbour cells to the present cell of interest. This signalling can be performed over standardized interfaces, like Iub/Iur, or over proprietary interfaces. FIG. 12 illustrates one possible embodiment, where a neighbour cell interference power estimate information element 62 is signalled from a neighbour NodeB 10B over a Iub interface 66 to the associated RNC 65B. In this embodiment, the neighbour NodeB 10B belongs to a different RNC than the present NodeB, and the information element 62 is forwarded over the Iur interface 67 to the own RNC 65A and finally over the Iub interface 66 to the NodeB 10A in question. If the NodeBs are connected to the same RNC, the Iur communication becomes unnecessary. In alternative embodiment, other types of signalling of the neighbour cell interference power estimate can be utilized, e.g. different proprietary interfaces. Such proprietary interfaces may even be provided directly between neighbouring NodeBs. The particular details of this signalling are not of crucial importance to the main ideas of the present embodiments, as long as the information is provided. For the present embodiment it is sufficient to understand that such signalling of interference metrics like neighbour cell interference power and own cell power indeed is feasible.

The above mentioned signalling is performed continuously, with high rate. This means that at each time instance each uplink cell has instantaneous estimates of the estimated total (experienced) neighbour cell interference power, caused by the own cell UE transmission of all the neighbour cells. Each uplink cell has also instantaneous estimates of the estimated own cell transmissions of each of the neighbour cells.

This allows for creation of a model that explains the experienced neighbour cell interference power as the sum of the impacts of the own cell UE transmissions of the UEs in each neighbour cell. In order to account for the average channel between all UEs of a neighbour cell and the particular cell of interest, each own cell power is multiplied by a parameter, denoted the coupling factor. The Appendix A gives the mathematical details, see e.g. equation (C1).

The model (C1) of the experienced neighbour cell interference power is valid at each time instant. It is then realized that a number of equations (C1) can be defined, one for each of a number of time instants. Together these equations form a systems of equations that can be solved for the unknown coupling factors, as soon as a sufficient number of equations (C1) are available, to allow the coupling factors to be computed. In fact, least squares solutions and Kalman filter techniques are preferably used for this purpose, as explained in Appendix C. However, many other techniques can be applied for this purpose in alternative embodiments.

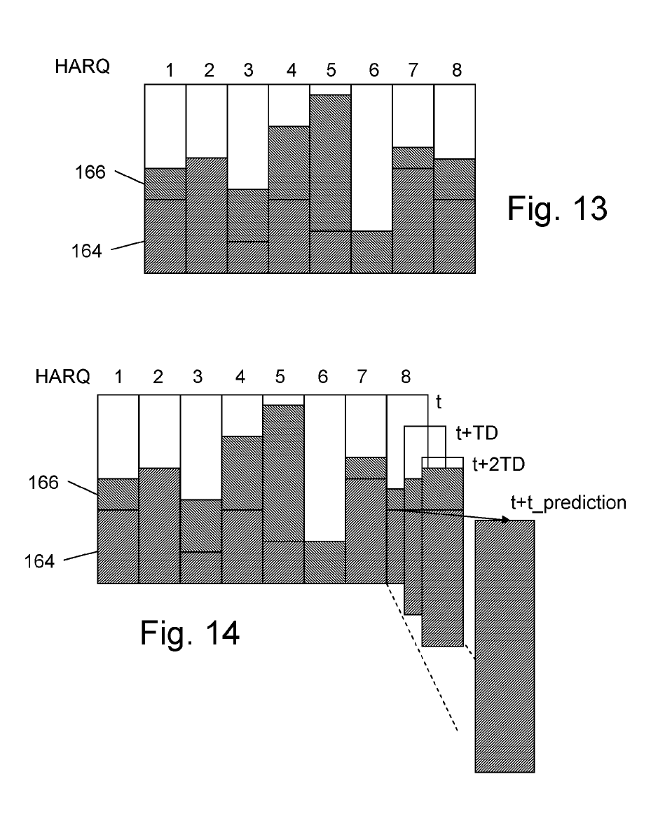

In a system having 8 TD slots of each 2 ms, there are hence 8 such estimates of coupling factors describing the effect of scheduled traffic, on neighbour cells, one for each TD slot. The situation is schematically depicted in FIG. 13. The TD structure, the HARQ processes and predicted neighbour cell interference in a neighbour cell 164, based on coupling factors are there illustrated. Note that thermal noise is not shown. Unknown interference, generated by users in the neighbour cell is denoted by 166.

Now, every 16:th millisecond such an estimate of coupling factors is available in each TD slot. A multiplication of the coupling factor with the own cell power then provides a prediction of the neighbour cell interference power impact from the own cell, onto each of the considered neighbour cells. This prediction is denoted P_{i,neighbor,predicted}(t). Here i is an index denoting the impacted neighbour cell.

By appropriate filtering, it is possible to estimate the current level of the predicted neighbour cell interference power impact. This can in one embodiment be performed e.g. using a Kalman filter based on a trend model. Together with the estimated current level of the predicted neighbour cell interference power impact, the rate of change of the neighbour cell interference power impact can be estimated. A trend model suitable for this purpose is straightforward to write in state space form as:

$$\begin{matrix}( \begin{matrix}{x}_{i , neighbor , predicted} ( t + {T}_{TD} ) \\ {i , neighbor , predicted}_{} ( t + {T}_{TD} )\end{matrix} ) = ( \begin{matrix}1 & {T}_{TD} \\ 0 & 1\end{matrix} ) ( \begin{matrix}{x}_{i , neighbor , predicted} ( t ) \\ {i , neighbor , predicted}_{} ( t )\end{matrix} ) + ( \begin{matrix}{w}_{i , neighbor , predicted} ( t ) \\ {i , neighbor , predicted}_{} ( t )\end{matrix} ) & ( 8 ) \\ {P}_{i , neighbor , predicted} ( t ) = \begin{matrix}( 1 & 0 )\end{matrix} ( \begin{matrix}{x}_{i , neighbor , predicted} ( t ) \\ {i , neighbor , predicted}_{} ( t )\end{matrix} ) + {e}_{i , neighbor , predicted} ( t ) . & ( 9 )\end{matrix}$$

Here (x_{i,neighbor,predicted}(t) & x_{i,neighbor,predicted}(t))^{T} denotes the state vector, with the second component representing the rate of change state variable. Further, T_{TD} denotes the time between TD slot activity. The vector (w_{i,neighbor,predicted}(t) & w_{i,neighbor,predicted}(t))^{T} denotes the systems noise, P_{i,neighbor,predicted}(t) denotes the estimated neighbour cell interference power impact, and e_{i,neighbor,predicted} denotes the neighbour cell interference power impact estimation error. Together with statistical assumptions on the covariances of the errors as given by:

$$\begin{matrix}{R}_{1 , neighbor} = E [ ( \begin{matrix}{w}_{neighbor} ( t ) & {neighbor}_{} ( t ) ) ( \begin{matrix}{w}_{neighbor} ( t ) \\ {neighbor}_{} ( t )\end{matrix} )\end{matrix} ] & ( 10 ) \\ {R}_{2} = E ⌊ {e}_{neighbor}^{2} ( t ) ⌋ . & ( 11 )\end{matrix}$$

all information is available for application of the Kalman filter of (A17)

Given the estimate (\hat{x}_{i,neighbor,predicted}(t|t) & \hat{x}_{i,neighbor,predicted}(t| t))^{T}, it becomes possible to predict ahead in time, using

\hat{x}_{i,neighbor,predicted}(t+t_{prediction})=\hat{x}_{i,neighbor,predicted}(t|t)+t_{prediction}& \hat{x}_{i,neighbor,predicted}(t|t) (12)

The filtering and prediction is illustrated in FIG. 14.

Given this prediction it can be investigated if the value of the interference is of such a character that an outgoing soft handover to a neighbour cell i would have the potential to create very high interference. If it is, then preparatory actions can be taken by the scheduler, in order to avoid excessive RoT values in the impacted neighbour TD slot, in case a blind handover would be undertaken. This is further discussed below.

The principles illustrated in FIG. 14 can in one embodiment be utilized separately. In another embodiment, the principles illustrated in FIG. 14 can be utilized in combination with the principles illustrated in FIG. 6.

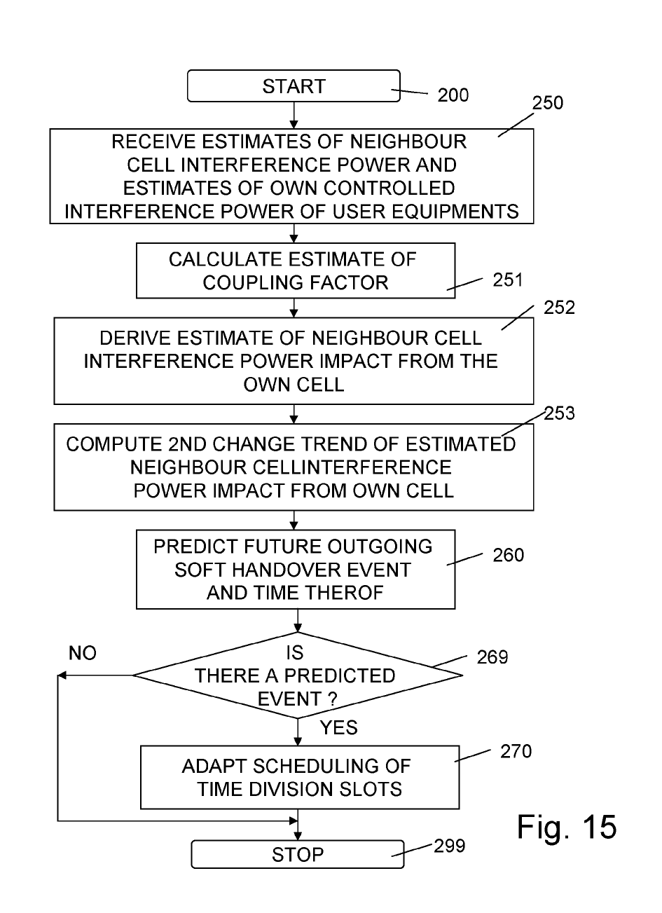

FIG. 15 illustrates a flow diagram of steps of an embodiment of a method for assisting in soft handover procedures in WCDMA time division schedules. The method starts in step 200. In step 250, estimates of a respective neighbour cell interference power and estimates of a respective own controlled interference power of user equipments of each respective cell are received from neighbour cells. In step 251, an estimate of a coupling factor is calculated for each time division slot. The estimate of the coupling factor describes the effect of scheduled traffic of one cell on the interference power of the neighbour cell. In step 252, an estimate of a neighbour cell interference power impact from the own cell is derived for each time division slot and each neighbour cell. In step 253, a second change trend of the estimated neighbour cell interference power impact from the own cell is computed for each time division slot and each neighbour cell. In step 260, a future outgoing soft handover event of a UE from the first NodeB to a neighbour NodeB is predicted. Also, a future outgoing soft handover time for the future outgoing soft handover event is predicted. These predictions are based on the second change trend of the estimated neighbour cell interference power impact from the own cell. The step thus predicts ahead in time that a soft handover event is likely to occur. If a future outgoing soft handover event is predicted, as decided in step 269, an adaptation step 270 is performed, otherwise the process ends in step 299. In step 270, scheduling of time division slots is adapted in the first NodeB. This adaptation is performed before the predicted future outgoing soft handover time. The adaptation is configured for creating interference power headroom for the predicted future outgoing soft handover event. The process ends in step 299.

The steps in FIG. 15 can in one embodiment be performed as a separate process. In another embodiment, the steps in FIG. 15 are combined with the steps of FIG. 4.

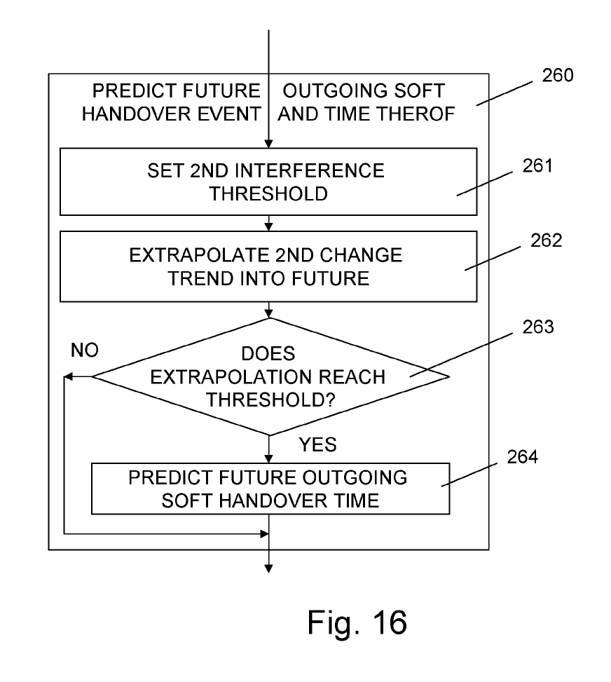

In a particular embodiment, as illustrated in FIG. 16, the step 260 of predicting a future outgoing soft handover event comprises the use of a threshold. In step 261, a second interference threshold is set. In step 262, the second change trend is extrapolated into the future. In step 263, it is decided if the extrapolated second change trend reaches the second interference threshold. If the extrapolated second change trend reaches the second interference threshold the future outgoing soft handover event is predicted to occur. Otherwise, no prediction is made. If a prediction is made, the future outgoing soft handover time is predicted in step 264 as the time at which the extrapolated second change trend reaches the second interference threshold.

In an alternative embodiment, step 262 can be performed before step 261. In a further alternative embodiment, steps 261 and 262 can be performed at least partly simultaneously or intermittently.

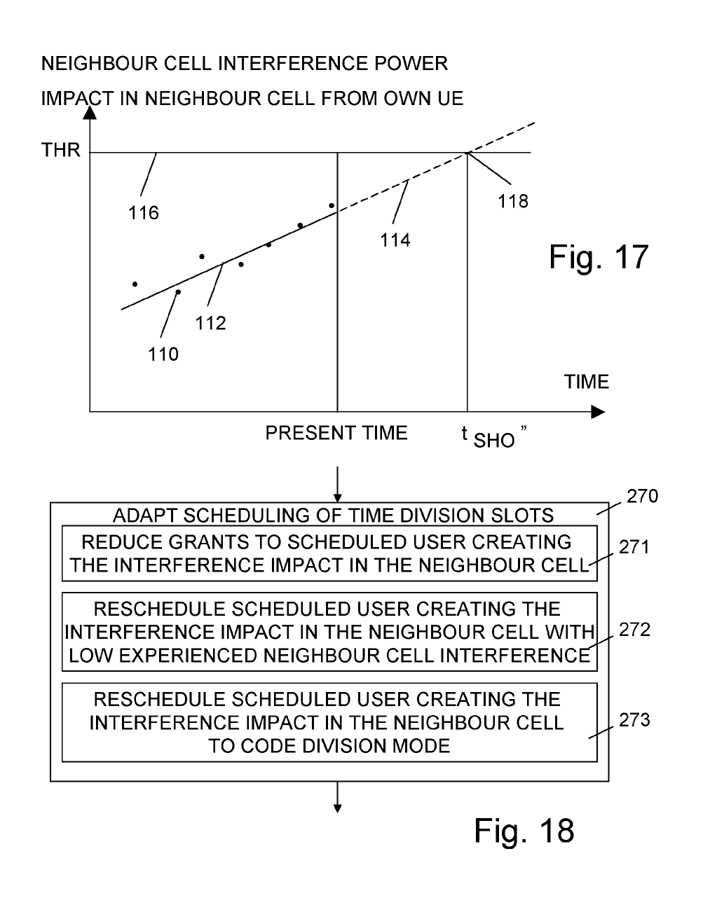

This embodiment can be further understood by referring to FIG. 17, illustrating a diagram of predicted high bandwidth neighbour cell interference powers 110 in neighbour cell caused by an own UE for a particular TD slot as a function of time. The computed second change trend of the estimated high bandwidth neighbour cell interference power in neighbour cell is illustrated by the full line 112. The change trend is extrapolated into the future, i.e. ahead of a present time, as illustrated by the broken line 114. The second interference threshold is illustrated as the line 116. In the present example, the extrapolated second change trend 114 reaches the second interference threshold 116 at the point 118, and this gives rise to a prediction of a future outgoing soft handover event to occur. The future outgoing soft handover time t_{SHO}″ is predicted as the time of the point 118.

As stated above, scheduling preparation actions are preferably due to predicted neighbour cell impact possibly triggering TD soft handover. Increasing predicted interference impact over time in a TD slot in a neighbour cell can be an indication that a soft handover is immediate. As also described above, the TD scheduler then use the prediction to find a prediction time in the future when the neighbour cell interference impact level is expected to give a soft handover. In one embodiment, a tentative time for a soft handover is when the neighbour cell interference impact level reaches a preconfigured interference threshold.

The TD scheduler initiates actions in order to create interference headroom for the tentative soft handover. In a particular embodiment, such actions are initiated only in case the prediction time is below a preconfigured time threshold, thus not reacting on possible events too far in the future. A similar effect can in another embodiment be achieved by utilizing a maximum future prediction time of the trend prediction.

The actions initiated by the TD scheduler preferably adapt the scheduling of the time division slots of UEs. In one embodiment, the grants to the scheduled user that is creating the interference impact in the neighbour cell are reduced. In another embodiment, the scheduled user that is creating the interference impact in the neighbour cell is re-scheduled to other TD slots, where the experienced neighbour cell interference is low. Such TD slots should on average be less loaded in the neighbour cell. In yet another embodiment, the user creating the interference impact in the TD slot in question is re-scheduled to the Code Division Multiplex (CDM) mode. In further embodiments, two or more of the above suggested actions are performed together. Here, CDM is the usual WCDMA uplink mode, not subject to TD scheduling. It is noted that the filtering, prediction, and actions may be performed on a regular basis, even at the same rate as the TD-scheduling.

In a particular embodiment, as illustrated in FIG. 18, the step 270 of adapting comprises, if the predicted future outgoing soft handover event is predicted to occur based on said estimated high bandwidth neighbour cell interference power in a particular second time division slot, at least one of the steps 271, 272 and 273. In step 271, grants to the scheduled user creating the interference impact in the neighbour cell are reduced. In step 272, the scheduled user creating the interference impact in the neighbour cell is rescheduled to time division slots where the experienced neighbour cell interference is low, i.e. typically to time division slots with more headroom. In step 273, the scheduled user creating the interference impact in the neighbour cell is rescheduled to code division mode. Thus, in different embodiments, the steps 271, 272 and 273 can be performed alternatively or together. The actual choice of action is preferably determined based on the actual application situation.

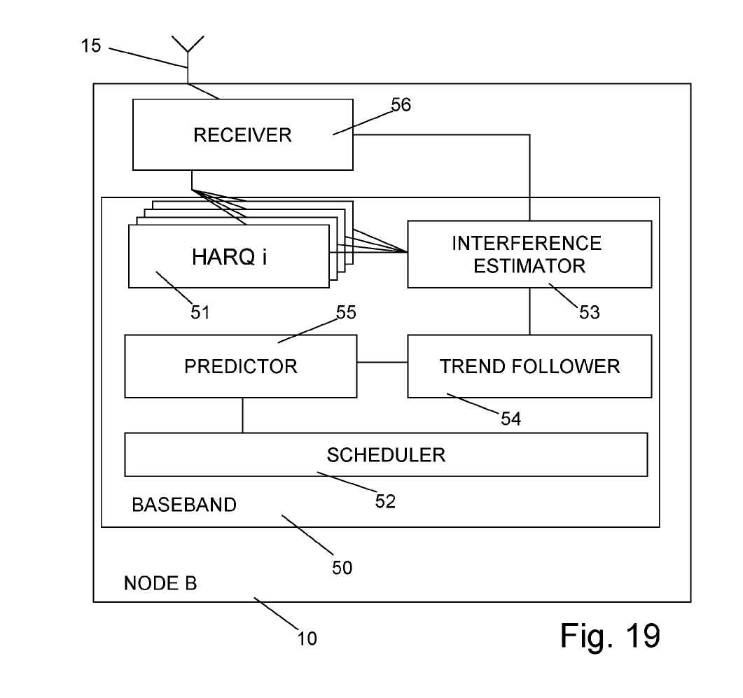

In FIG. 19, an embodiment of a NodeB 10 in a WCDMA communication system is schematically illustrated. An uplink baseband section 50 is connected to an antenna 15. The uplink baseband section 50 comprises a scheduler 52 for a WCDMA time division scheme, utilizing a number of time division slots. The antenna 15 is connected via a receiver 56, to a HARQ 51, one for each time division slot. The receiver 56 is configured for receiving estimates of a respective neighbour cell interference power and estimates of a respective own controlled interference power of user equipments of each respective cell. An interference estimator 53 is connected to the HARQs 51 and to the receiver 56. The interference estimator 53 is configured for calculating, for each time division slot, an estimate of a coupling factor, describing the effect of scheduled traffic of one cell on interference power of neighbour cells. The interference estimator 53 is further configured for deriving an estimate of a neighbour cell interference power impact from the own cell for each time division slot and each neighbour cell. A trend follower 54 is connected to the interference estimator 53. The trend follower 54 is configured for computing a second change trend of the estimated neighbour cell interference power impact from the own cell for each time division slot and each neighbour cell. A predictor 55 is connected to the trend follower 54. The predictor 55 is configured for predicting a future outgoing soft handover event of a UE from the first NodeB to a neighbour NodeB. The predictor 55 is also configured for predicting a future outgoing soft handover time for the future outgoing soft handover event, if any. The predictor 55 is configured to base its predictions on the second change trend of the estimated neighbour cell interference power impact from the own cell obtained from the trend follower 54. The scheduler 52 is connected to the predictor 55. The scheduler is configured for adapting scheduling of time division slots before the predicted future outgoing soft handover time. This adaptation is performed in such a way that it results in creation of interference power headroom for the predicted future outgoing soft handover event.

In one particular embodiment, the predictor is configured for setting a second interference threshold and for extrapolating the second change trend into the future. The predictor is further configured for predicting the future outgoing soft handover event to occur if the extrapolated second change trend reaches the second interference threshold. The predictor is also configured for predicting the future outgoing soft handover time as the time at which the extrapolated second change trend reaches the second interference threshold.

In one particular embodiment, the predicted future outgoing soft handover event is predicted to occur based on the estimated high bandwidth neighbour cell interference power in a particular second time division slot. The scheduler is then configured for reducing grants to the scheduled user creating the interference impact in the neighbour cell, rescheduling the scheduled user creating the interference impact in the neighbour cell to time division slots where the experienced neighbour cell interference is low and/or rescheduling the scheduled user creating the interference impact in the neighbour cell to code division mode. The proposed functionalities of the scheduler can in other words be provided separately or in any combination.

The NodeB 10 in FIG. 19 can in one embodiment be performed as a separate unit. In another embodiment, the functionalities of the NodeB in FIG. 19 are incorporated into the NodeB of FIG. 10. In a preferred embodiment of such a combined NodeB, the different parts, e.g. scheduler, predictor, interference estimator and trend follower, are implemented as common parts, with combined functionalities.

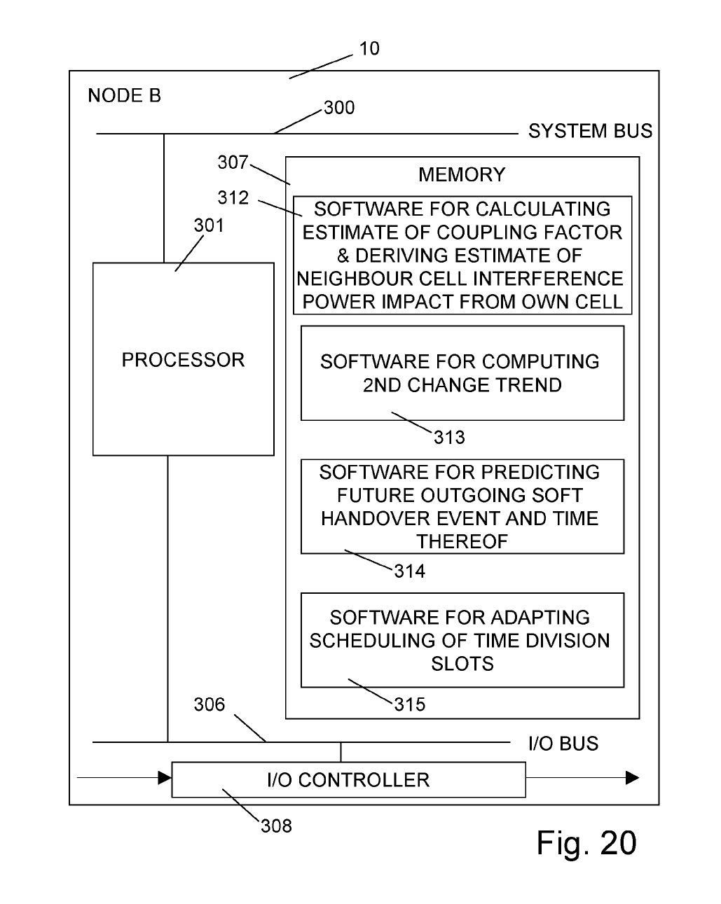

In one particular embodiment, the soft handover assisting functionalities in a NodeB are implemented by a processor by means of software. Such an implementation example, is illustrated in FIG. 20 as a block diagram. This embodiment is based on a processor 301, a memory 307, a system bus 300, an input/output (I/O) controller 308 and an I/O bus 306. In this embodiment power measurements for each HARQ and the estimates of a respective neighbour cell interference power and estimates of a respective own controlled interference power of user equipments of each respective cell are received by the I/O controller 308 and are stored in the memory 307. The I/O controller 308 also controls the issue of the scheduler actions. The processor 301, which may be implemented as one or a set of cooperating processors, executes software components stored in the memory 307 for performing the soft handover assistance activities. The processor 301 communicates with the memory 307 over the system bus 300. In particular, software component 312 may implement the functionality of calculating, for each time division slot, an estimate of a coupling factor and deriving an estimate of a neighbour cell interference power impact from the own cell for each time division slot and each neighbour cell of block 53 (FIG. 19). Software component 313 may implement the functionality of computing a second change trend of the estimated neighbour cell interference power impact from the own cell for each time division slot and each neighbour cell of block 54 (FIG. 19). Software component 314 may implement the functionality of predicting a future outgoing soft handover event of a UE from the first NodeB to a neighbour NodeB and a future outgoing soft handover time for the future outgoing soft handover event of block 55 (FIG. 19). Software component 315 may implement the functionality of adapting scheduling of time division slots before the predicted future outgoing soft handover time of block 52 (FIG. 19).

As is now clear, functionality for mitigating increasing neighbour cell interference in TD can be defined, based both on neighbour cell interference estimation in the target cell, and based on neighbour cell interference prediction on the target cell.

In the first case, it is hence known that a TD user in a neighbour cell is causing increasing interference. A further action that can be taken is to calculate a sequence of relative grants, i.e. power down commands, to this user as a preparation. These could then be sent as soon as the soft handover becomes a fact. Such a transmission can be performed according to routines, known as such, in prior art, and are therefore not further discussed. The calculation could be based on levels calculated to be tolerable for existing users in the TD slots of the own cell.

One particular embodiment of a method based on these ideas could be based on the embodiment of FIG. 4. The method is thereby amended by a further step of determining from which neighbour cell the predicted future incoming soft handover event is predicted to occur. The step of scheduling is then modified to comprise calculation of relative grants for the neighbour cell from which the predicted future incoming soft handover event is predicted to occur, for adapting a transmitting power of a user equipment of the predicted future incoming soft handover event to a tolerable level for existing users in the cell of the first NodeB. The method further comprises the step of sending the relative grants to the neighbour cell from which the predicted future incoming soft handover event is predicted to occur.

One particular embodiment of a NodeB based on these ideas could be based on the embodiment of FIG. 10. The NodeB thereby further comprises a transmitter, connected to the scheduler. The predictor is further configured for determining from which neighbour cell the predicted future incoming soft handover event is predicted to occur. The scheduler is further configured for calculating relative grants for the neighbour cell from which the predicted future incoming soft handover event is predicted to occur, for adapting a transmitting power of a user equipment of the predicted future incoming soft handover event to a tolerable level for existing users in the cell of the first NodeB. The transmitter is configured for sending the relative grants to the neighbour cell from which the predicted future incoming soft handover event is predicted to occur.

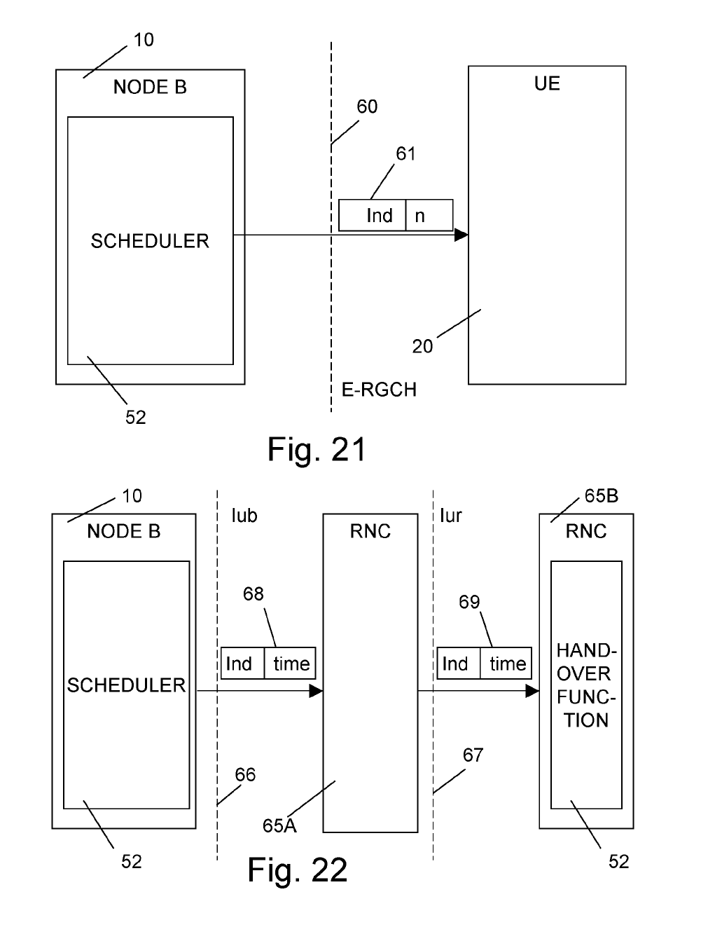

Still a further possibility is to extend the relative grant concept to allow more than the currently available “one power step down”. This could be done in general, or only for TD users. A signalling system that accomplishes this is depicted in FIG. 21. A scheduler 52 in a NodeB 10 communicates over the E-RGCH interface 60 with a UE 20. That figure shows a new information element 61 carrying an enhanced relative grant command over the Enhanced Relative Grant Channel (E-RGCH) in WCDMA. The interpretation of the information “n” could be “n power steps down” or “set new power level n”. there may also be an indicator “ind” that informs the UE if the relative grant shall be interpreted as the legacy “one step down”, “n steps down” or “set power level n”.

Since soft handovers are triggered by the RNC, a further possible action would be to let the NodeB inform the RNC about the fact that an incoming soft handover is predicted at a certain time ahead by the NodeB. This means that this information needs to be signalled over Iub and over Iur, as illustrated in FIG. 22. A scheduler 52 in a NodeB 10 communicates over the Iub interface 66 with the associated RNC 65A. An information element 68 comprises an indicator, stating a predicted incoming soft handover. Optionally, a predicted time indicating when the soft handover is needed/predicted can also be provided. This information can then be further transferred from the own RNC 65A to the RNC 65B of the cell in which the UE tentative to the soft handover is situated. This takes place over the Iur interface 67 and comprises an information element 69 which comprises at least a part of the information of the information element 68.

The ideas of the present embodiments have been tested by simulations. The basis for the data generation is a large set of UL power files generated in a high fidelity system simulator. The files represent bursty traffic, with varying mix of speech and data traffic, at different load levels.

These data files are then combined in different ways by MATLAB code which generates the UL power components, i.e. own cell traffic, neighbour cell traffic, thermal noise and the summed up RTWP. The load factor of the own cell is also computed. The simulation operator can e.g.:
Select the average power levels of the components, with respect to the thermal noise floor level
Select the number of neighbours used for neighbour cell interference.
Set the load utilization probability of the own cell, fix or varying between two limits.
Set the loop delay of the load factor, related to grant loop delay.
Set daily load patterns, and perturb these day to day by a randomization algorithm.

MATLAB reference code implementing the disclosed algorithm was used for performance simulations. Each run was 720000 10 ms TTIs, i.e. 2 h of traffic. The load utilization probability was varied. The variation was very fast with changes every few TTIs. The mean power levels of the neighbour cell interference and the own cell were also varied between simulations, as was the load factor bias.

The results clearly show that the load utilization is estimated accurately and with a bandwidth close to the TTI bandwidth. This is not surprising, given the fact that the quantity is accurately measured and integrated in the estimation algorithm.

The neighbour cell interference estimate has also been verified. The algorithm is able to track the true signal at TTI bandwidth, and with an inaccuracy below 10% (rms). The average error is 10.4 dB below the mean neighbour cell power in the simulations. Unless the load factor bias would be integrated in the model used by the estimator, it will limit the performance of the neighbour cell interference estimate instead.

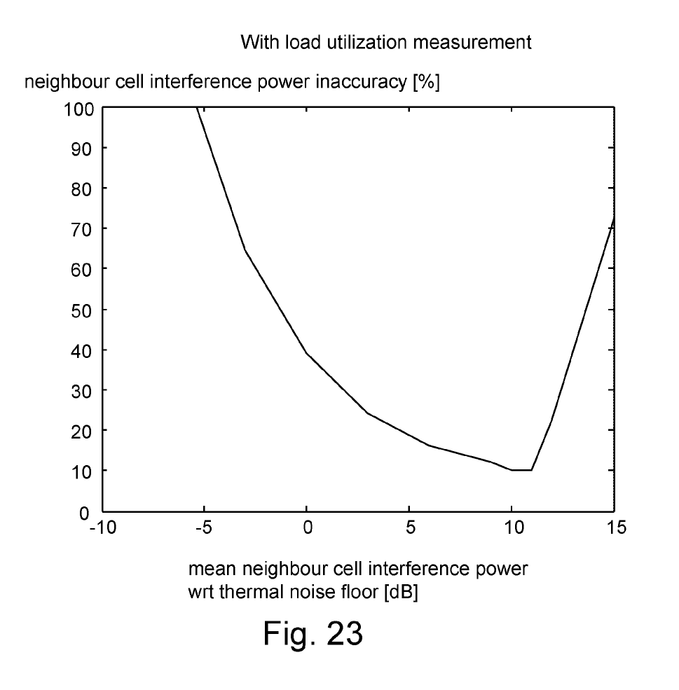

Repeated simulations were then used to characterize the estimator performance. First, the accuracy of the neighbour cell interference estimate was addressed as a function of the involved power levels. FIG. 23 plots the inaccuracy of the neighbour cell interference estimate, as a function of the mean neighbour cell interference power. The scheduled mean own cell interference power is 5 dB above the thermal noise power floor level.

It is evident that a first factor that affects the inaccuracy is the signal to noise ratio of the neighbour cell interference in the simulated signals that are used for estimation of the neighbour cell interference power. The inaccuracy is reduced when the simulated neighbour cell interference grows at the expense of the own cell power. This is however true only up to a limit where the mean RoT becomes too high. Then the estimator has to work in a very steep region of the load curve, and above a certain level the estimation problem seems to become too sensitive, resulting in a rapidly increasing inaccuracy.

The result means that the accuracy of the estimator is good in the regions where neighbour cell interference is high and when it is affecting performance. In other words, where the neighbour cell interference is well above the thermal noise power floor, and when it is large as compared to the own cell power. This holds up to interference levels of about 10 dB mean RoT. It should be noted that mean RoTs above 10 dB represent a very high load, with RoT peaks at least at 20-25 dB. Hence the results indicate that the estimator should be capable to provide useful estimates in the majority of the interference region of interest.

The above presented embodiments disclose means for mitigation of soft handover collision risks, in case blind algorithms would be used for this purpose. Different embodiments use estimates of experienced neighbour cell interference power in a NodeB to achieve parts of this goal. In addition, some embodiments use estimated coupling factors, describing the impact of scheduling decision on the interference level in neighbour cells, to achieve another part of the objective.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

### APPENDIX A

In this appendix a new high performing estimator algorithm for neighbour cell interference estimation is proposed. The scope is to perform a joint estimation of P_{neighbor}(t)+P_{N} (t), P_{N} (t), P_{neighbor}(t) and the load utilization probability p_{load}(t). The proposed and preferred embodiment is provided by an extended Kalman filter (EKF). Furthermore, an algorithm for estimation of neighbour cell impact factor is discussed.

The estimation algorithm will use the following information:
Measurements of P_{RTWP}(i), with a sampling rate of T_{RTWP}=k_{RTWP}TTI, k_{RTWP}εZ+. Available for each antenna branch.
Computed load factors L_{own}(t), with a sampling rate of T_{L}=k_{L}TTI, k_{L}εZ+. Available per cell. Valid on cell level, not necessarily valid on antenna branch level with Rx diversity.
The loop delay T_{D} between the calculation of L_{own}(t), and the time it takes effect on the air interface. The loop delay is dependent on the TTI. Available for and valid per cell.
Measured load factors L̅_{own}(t), with a sampling rate of T _{L̅}=k _{L̅}TTI, k _{L̅}εZ+. Available per cell. Valid on cell level, not necessarily valid on antenna branch level with Rx diversity. Obtained after TFCI decoding.
The loop delay T̅_{D} between the calculation of L̅_{own}(t), and the time it takes effect on the air interface. The loop delay is dependent on the TTI and larger than T_{D} since the measured load factor calculation requires TFCI and E-TFCI decoding.

The states are selected as:

x₁(t)=p_{load}(t) (A1)

x₂(t)=P_{neighbor}(t)+P_{N}(t) (A2)

x₃(t)=Δ L̅_{own}(t) (A3)

x₄(t)=x₁(t−T_{TTI}). (A4)

Since an additional decoding delay of about one TTI affects the loop, x₁(t) needs to be delayed by an extra state to define the fact that the load utilization probability measurement is subject to an additional delay of one TTI. The state x₄(t) is used for this purpose. ΔL_{own}(t) represents a slowly varying load factor bias error in the measurement model.

Note, that in an alternative embodiment, the first state can be introduced as the estimated own cell load factor.

An instantaneous load on the uplink air interface ahead of time can typically be used for EUL scheduling. One example of such load estimation is given in Appendix B.

The first measured signal that is available for processing is P_{RTWP}(t). The scheduled load of the own cell L_{own}(t) is a computed quantity, currently based on SINR measurements. For this reason a measurement model of P_{RTWP}(t) is needed, expressed in terms of the states, computed quantities and a measurement uncertainty. Towards this end it is first noted that the load of (B6) does not account for the load utilization probability p_{load}(t). Neither does it account for the delay T_{D}.

To model the load utilization effect, and to compensate for semi-constant load factor errors, considerations of (B5) suggests that load underutilization can be modelled by a modification of (B4) and (B5) to:

$$\begin{matrix}{L}_{own , utilized} ( t ) = {\sum }_{i = 1}^{I} {P}_{load} ( t ) {L}_{i} ( t - {T}_{D} ) + Δ {\overline{L}}_{own} ( t ) = {p}_{load} ( t ) {L}_{own} ( t - {T}_{D} ) + Δ {\overline{L}}_{own} ( t ) & ( A5 ) \\ {P}_{RTWP} ( t ) = {L}_{own , utilized} ( t ) {P}_{RTWP} ( t ) + {P}_{neighbor} ( t ) + {P}_{N} ( t ) & ( A6 )\end{matrix}$$

which results in

$${P}_{RTWP} ( t ) = \frac{1}{1 - {L}_{own} ( t - {T}_{D} ) {p}_{load} ( t ) + Δ {\overline{L}}_{own} ( t )} ( {P}_{neighbor} ( t ) + {P}_{N} ( t ) ) \qquad ( A7 )$$

After addition of a zero mean white measurement noise e_{RTWP}(t) and replacement of variables by the states of (A1)-(A4), the following nonlinear measurement equation results:

$$\begin{matrix}{y}_{RTWP} ( t ) = \frac{{x}_{2} ( t )}{1 - {L}_{own} ( t - {T}_{D} ) {x}_{1} ( t ) + {x}_{3} ( t )} + {e}_{RTWP} ( t ) & ( A8 ) \\ {R}_{2 , RTWP} ( t ) = E ⌊ {e}_{RTWP}^{2} ( t ) ⌋ & ( A 9 )\end{matrix}$$

Here y_{RTWP}(t)=P_{RTWP}(t) and R_{2,RTWP}(t) denotes the (scalar) covariance matrix of e_{RTWP}(t).

The load of the own cell is computed using both EUL and R99 traffic, hence in this case the delay is valid for both.

In case the own cell load would be estimated instead, L_{own}(t−T_{D})x₁(t) would be expressed by a state directly modelling the estimated load factor of the own cell. The own cell load factor appearing in (A8) is treated as a known time varying factor in that equation, not as an estimate.

Equation (A8) represents a nonlinear load curve, expressed in terms of the estimated sum of neighbour cell interference and noise floor power (x₂(t)), the estimated load utilization probability (x₂(t)), and the estimated load factor bias (x₃(t)). Further the computed (“received”) load factor is used in the nonlinear load curve. Equation (A8) relates the momentary combined effect of the estimated quantities and received quantities to the left hand side of the equation, i.e. the momentary measurement of the wideband power.

The measurement can be made available per cell. In a first step the decoded TFCIs and E-TFCISs show which grants the UE actually used in the last TTI. This provides the information needed to compute the actual load factor of the last TTI, i.e. to compute:

$${p}_{load} ( t ) = \frac{{\overline{L}}_{own} ( t - {T}_{D} )}{{L}_{own} ( t - {T}_{D} )} . \qquad ( A 10 )$$

With this modification the measurement model for the load utilization probability measurement becomes:

y_{loadUtilization}(t)=x₄(t)+e_{loadUtilization}(t) (A11)

R_{2,loadUtilization}(t)=E[e_{loadUtilization}(t)]². (A12)

The transformation (A10) essentially replaces the granted load factor, L_{own}(t−T_{D}), with the load factor computed based on received Transport Format Combination Indices (TFCIs) and Extended Transport Format Combination Indices (E-TFCIs).

Random walk models are adapted for the state variables x₁(t) and x₂(t) In order to avoid a drifting bias correction of the load factor, an autoregressive model is used for the state x₃(t). A further motivation for this is that the state is expected to model errors that over an ensemble have a zero mean. Hence the following state model results from the states of (A1)-(A4):

$$\begin{matrix}x ( t + {T}_{TTI} ) ≡ ( \begin{matrix}{x}_{1} ( t + {T}_{TTI} ) \\ {x}_{2} ( t + {T}_{TTI} ) \\ {x}_{3} ( t + {T}_{TTI} ) \\ {x}_{4} ( t + {T}_{TTI} )\end{matrix} ) = ( \begin{matrix}1 & 0 & 0 & 0 \\ 0 & 1 & 0 & 0 \\ 0 & 0 & a & 0 \\ 1 & 0 & 0 & 0\end{matrix} ) ( \begin{matrix}{x}_{1} ( t ) \\ {x}_{2} ( t ) \\ {x}_{3} ( t ) \\ {x}_{4} ( t )\end{matrix} ) + ( \begin{matrix}{w}_{1} ( t ) \\ {w}_{2} ( t ) \\ {w}_{3} ( t ) \\ {w}_{4} ( t )\end{matrix} ) & ( A13 ) \\ {R}_{1} ( t ) = E [ ( \begin{matrix}{w}_{1} ( t ) \\ {w}_{2} ( t ) \\ {w}_{3} ( t ) \\ {w}_{4} ( t )\end{matrix} ) ( {w}_{1} ( t ) {w}_{2} ( t ) {w}_{4} ( t ) {w}_{4} ( t ) ) ] . & ( A14 )\end{matrix}$$

Note that by setting a=1 a random walk model is obtained for all states. Again, a diagonal covariance matrix is commonly used. The last component of the system noise is preferably selected to be very small, reflecting the pure delay it is intended to model.

The state space model behind the extended Kalman filter (EKF) is:

x(t+T)=A(t)x(t)+B(t)u(t)+w(t) (A15)

y(t)=c(x(t))+e(t). (A16)

Here x(t) is the state vector, u(t) is an input vector that is not used here, y(t) is an output measurement vector, w(t) is the so called systems noise that represents the model error, and e(t) denotes the measurement error. The matrix A(t) is the system matrix describing the dynamic modes, the matrix B(t) is the input gain matrix, while the vector c(x(t)) is the, possibly nonlinear, measurement vector which is a function of the states of the system. Finally t represents the time and T represents the sampling period.

The general case with a nonlinear measurement vector is considered here. For this reason the extended Kalman filter needs to be applied. This filter is given by the following matrix and vector iterations,

$${ Initialization t = {t}_{0} \\ \hat{ x} ( 0 \vert - 1 ) = {x}_{0} \\ P ( 0 \vert - 1 ) = {P}_{0} \\ It eration \\ t = t + T \\ C ( t ) = \frac{\partial c ( x )}{\partial x} \vert}_{x = \hat{x} ( t \vert t - T )} \\ {K}_{f} ( t ) = P ( t \vert t - T ) {C}^{T} ( t ) {( C ( t ) P ( t \vert t - T ) {C}^{T} ( t ) + {R}_{2} ( t ) )}^{- 1} \\ \hat{x} ( t \vert t ) = \hat{x} ( t \vert t - T ) + {K}_{f} ( t ) ( y ( t ) - c ( \hat{x} ( t \vert t - T ) ) ) \\ P ( t \vert t ) = P ( t \vert t - T ) - {K}_{f} ( t ) C ( t ) P ( t \vert t - T ) \\ \hat{x} ( t + T \vert t ) = A \hat{x} ( t \vert t ) + B u ( t ) \\ P ( t + T \vert t ) = AP ( t \vert t ) {A}^{T} + {R}_{1} . \\ End \qquad ( A17 )$$

The quantities introduced by the filter iterations (A17) are as follows. \hat{x}(t|t−T) denotes the state prediction, based on data up to time t−T, \hat{x}(t|t) denotes the filter update, based on data up to time t, P(t|t−T) denotes the covariance matrix of the state prediction, based on data up to time t−T, and P(t|t) denotes the covariance matrix of the filter update, based on data up to time t. C(t) denotes the linearized measurement matrix (linearization around the most current state prediction), K_{f}(t) denotes the time variable Kalman gain matrix, R₂(t) denotes the measurement covariance matrix, and R₁(t) denotes the system noise covariance matrix. It can be noted that R₁(t) and R₂(t) are often used as tuning variables of the filter. In principle the bandwidth of the filter is controlled by the matrix quotient of R₁(t) and R₂ (t).

Note that the extended Kalman filter, as such, is known in prior art. However, the way it is applied according to the measurement models and dynamic state models is completely novel. Note also that the specific EKF estimator, is one alternative prior art algorithm. In alternative embodiment other estimators could be used instead.

The quantities of the EKF for estimation of neighbour cell interference, load utilization load factor bias can now be defined. Using (A8)-(A9) and (A11)-(A14) it follows that:

$$\begin{matrix} C ( t ) = ( \begin{matrix}{C}_{11} ( t ) & {C}_{12} ( t ) & {C}_{13} ( t ) & 0 \\ 0 & 0 & 0 & {C}_{24} ( t )\end{matrix} ) & ( A18 ) \\ {C}_{11} ( t ) = \frac{{L}_{own} ( t - {T}_{D} ) {\hat{x}}_{2} ( t \vert t - {T}_{TTI} )}{{( 1 - {L}_{own} ( t - {T}_{D} ) {\hat{x}}_{1} ( t \vert t - {T}_{TTI} ) + {\hat{x}}_{3} ( t \vert t - {T}_{TTI} ) )}^{2}} & ( A19 ) \\ {C}_{12} ( t ) = \frac{1}{1 - {L}_{own} ( t - {T}_{D} ) {\hat{x}}_{1} ( t \vert t - {T}_{TTI} ) + {\hat{x}}_{3} ( t \vert t - {T}_{TTI} )} & ( A20 ) \\ {C}_{13} ( t ) = - \frac{{\hat{x}}_{2} ( t \vert t - {T}_{TTI} )}{{( 1 - {L}_{own} ( t - {T}_{D} ) {\hat{x}}_{1} ( t \vert t - {T}_{TTI} ) + {\hat{x}}_{3} ( t \vert t - {T}_{TTI} ) )}^{2}} & ( A21 ) \\ {C}_{24} ( t ) = 1 & ( A22 ) \\ {R}_{2} ( t ) = E [ ( \begin{matrix}{e}_{RTWP} ( t ) \\ {e}_{loadUtilization} ( t )\end{matrix} ) ( {e}_{RTWP} ( t ) {e}_{loadUtilization} ( t ) ) ] ( \begin{matrix}{R}_{2 , 11} ( t ) & {R}_{2 , 12} ( t ) \\ {R}_{2 , 12} ( t ) & {R}_{2 , 22} ( t )\end{matrix} ) & ( A23 ) \\ c ( \hat{x} ( t \vert t - {T}_{TTI} ) ) = ( \begin{matrix}\frac{{\hat{x}}_{2} ( t \vert t - {T}_{TTI} )}{1 - {L}_{own} ( t - {T}_{D} ) {\hat{x}}_{1} ( t \vert t - {T}_{TTI} ) + {\hat{x}}_{3} ( t \vert t - {T}_{TTI} )} \\ {\hat{x}}_{4} ( t \vert t - {T}_{TTI} )\end{matrix} ) & ( A24 ) \\ A = ( \begin{matrix}1 & 0 & 0 & 0 \\ 0 & 1 & 0 & 0 \\ 0 & 0 & a & 0 \\ 1 & 0 & 0 & 0\end{matrix} ) & ( A25 ) \\ B = 0 & ( A26 ) \\ \begin{matrix} {R}_{1} ( t ) = E [ ( \begin{matrix}{w}_{1} ( t ) \\ {w}_{2} ( t ) \\ {w}_{3} ( t ) \\ {w}_{4} ( t )\end{matrix} ) ( {w}_{1} ( t ) {w}_{2} ( t ) {w}_{3} ( t ) {w}_{4} ( t ) ) ] \\ = ( \begin{matrix}{R}_{1 , 11} ( t ) & {R}_{1 , 12} ( t ) & {R}_{1 , 13} ( t ) & {R}_{1 , 14} ( t ) \\ {R}_{1 , 12} ( t ) & {R}_{1 , 22} ( t ) & {R}_{1 , 23} ( t ) & {R}_{1 , 24} ( t ) \\ {R}_{1 , 13} ( t ) & {R}_{1 , 23} ( t ) & {R}_{1 , 33} ( t ) & {R}_{1 , 34} ( t ) \\ {R}_{1 , 14} ( t ) & {R}_{1 , 24} ( t ) & {R}_{1 , 34} ( t ) & {R}_{1 , 44} ( t )\end{matrix} ) .\end{matrix} & ( A27 )\end{matrix}$$

In order to execute the EKF, the state prediction and the state covariance prediction at time t given by the following equations are needed,

$$\begin{matrix}\hat{x} ( t \vert t - {T}_{TTI} ) ≡ ( \begin{matrix}{\hat{x}}_{1} ( t \vert t - {T}_{TTI} ) \\ {\hat{x}}_{2} ( t \vert t - {T}_{TTI} ) \\ {\hat{x}}_{3} ( t \vert t - {T}_{TTI} ) \\ {\hat{x}}_{4} ( t \vert t - {T}_{TTI} )\end{matrix} ) & ( A28 ) \\ P ( t \vert t - {T}_{TTI} ) = ( \begin{matrix}{P}_{11} ( t \vert t - {T}_{TTI} ) \\ {P}_{12} ( t \vert t - {T}_{TTI} ) \\ {P}_{13} ( t \vert t - {T}_{TTI} ) \\ {P}_{14} ( t \vert t - {T}_{TTI} )\end{matrix} \begin{matrix}{P}_{12} ( t \vert t - {T}_{TTI} ) \\ {P}_{22} ( t \vert t - {T}_{TTI} ) \\ {P}_{23} ( t \vert t - {T}_{TTI} ) \\ {P}_{24} ( t \vert t - {T}_{TTI} )\end{matrix} \begin{matrix}{P}_{13} ( t \vert t - {T}_{TTI} ) \\ {P}_{23} ( t \vert t - {T}_{TTI} ) \\ {P}_{33} ( t \vert t - {T}_{TTI} ) \\ {P}_{34} ( t \vert t - {T}_{TTI} )\end{matrix} \begin{matrix}{P}_{14} ( t \vert t - {T}_{TTI} ) \\ {P}_{24} ( t \vert t - {T}_{TTI} ) \\ {P}_{34} ( t \vert t - {T}_{TTI} ) \\ {P}_{44} ( t \vert t - {T}_{TTI} )\end{matrix} ) . & ( A29 )\end{matrix}$$

The equations (A18)-(A29) define the EKF completely, when inserted in (A17). The final step is to compute the neighbour cell interference estimate as:

\hat{P}_{neighbor}(t|t)=\hat{x}₂(t|t)−\hat{P}_{N}(t|t), (A30)

where \hat{P}_{N}(t|t) is preferably obtained by the techniques of T. Wigren and P. Hellqvist, in “Estimation of uplink WCDMA load in a single RBS”, Proc. IEEE VTC-2007 Fall, Baltimore, Md., USA, Oct. 1-3, 2007, of T. Wigren, in “Soft uplink load estimation in WCDMA”, IEEE Trans Veh. Tech., March, 2009 and/or of T. Wigren, in “Recursive noise floor estimation in WCDMA”, IEEE Trans. Veh. Tech., vol. 59, no. 5, pp. 2615-2620, 2010.

### APPENDIX B

An instantaneous load on the uplink air interface ahead of time can typically be used for EUL scheduling. Such an UL load prediction can be performed based on a Signal-to-Interference Ratio (SIR) as follows:

The prediction of uplink load, for a tentative scheduled set of users and grants, is based on the power relation:

$${P}_{RTWP} ( t ) - {P}_{N} ( t ) = {\sum }_{i = 1}^{N} {L}_{i} ( t ) {P}_{TRWP} ( t ) + {P}_{neighbor} ( t ) , \qquad ( B 1 )$$

where Lᵢ(t) is the load factor of the i:th user of the own cell and where P_{neighbor}(t) denotes the neighbour cell interference. The load factors of the own cell are computed as follows. First it is noted that

$$\begin{matrix}{( C / I )}_{i} ( t ) = \frac{{P}_{i} ( t )}{{P}_{RTWP} ( t ) - ( 1 - α ) {P}_{i}} = \frac{{L}_{i} ( t ) {P}_{RTWP} ( t )}{{P}_{RTWP} ( t ) - ( 1 - α ) {L}_{i} ( t ) {P}_{RTWP} ( t )} = \frac{{L}_{i} ( t )}{1 - ( 1 - α ) {L}_{i} ( t )} \\ ⇔ & ( B 2 ) \\ {L}_{i} ( t ) = \frac{{( C / I )}_{i} ( t )}{1 + ( 1 - α ) {( C / I )}_{i} ( t )} , i = 1 , … , I , & \end{matrix}$$

where I is the number of users in the own cell and a is the self-interference factor. The carrier to interferences, (C/I)ᵢ(t), i=1, . . . , I, are then related to the SINR (measured on the DPCCH channel) as follows

$$\begin{matrix}{( C / I )}_{i} ( t ) = \frac{{SINR}_{i} ( t )}{{W}_{i}} \frac{Rx Loss}{G} \times ( 1 + \frac{\begin{matrix}{β}_{DPDCH , i}^{2} ( t ) + {β}_{EDPCCH , i}^{2} ( t ) + \\ {n}_{codes , 1} ( t ) {β}_{EDPDCH , i}^{2} ( t ) + {β}_{HSDPCCH , i}^{2} ( t )\end{matrix}}{{β}_{DPCCH}^{2} ( t )} ) , & ( B3 ) \\ i = 1 , … , I . & \end{matrix}$$

Here W is the spreading factor, RxLoss represents missed receiver energy, G is the diversity gain and the β:s are the beta factors of the respective channels, assuming not active channels to have zero beta factors.

The UL load prediction then computes the uplink load of the own cell by a calculation of (B2) and (B3) for each user of the own cell, followed by the summation:

$${L}_{own} ( t ) = {\sum }_{i = 1}^{I} {L}_{i} ( t ) , \qquad ( B4 )$$

which transforms (B1) to

P_{RTWP}(t)=L_{own}(t)P_{RTWP}(t)+P_{neighbor}(t)+P_{N}(t). (B5)

A division with P_{N}(t) then shows that the RoT can be predicted k TTIs ahead as:

$$RoT ( t + kT ) = \frac{{P}_{neighbor} ( t ) / {P}_{N} ( t )}{1 - {L}_{own} ( t )} + \frac{1}{1 - {L}_{own} ( t )} . \qquad ( B6 )$$

The SIR based load factor calculation can be replaced by a power based one, where the basic definition of the load factor:

$${L}_{i} ( t ) = \frac{{P}_{i} ( t )}{{P}_{RTWP} ( t )} , \qquad ( B7 )$$

is used, instead of (B2). The advantage is that the parameter dependency is reduced. On the downside a measurement of the user power is needed. This is the method that is preferred as pre-requisite for the present embodiments.

### APPENDIX C

One embodiment of impact factor computation for neighbour cell interference power is presented here below.

When decisions are to be made e.g. about scheduling, it is important to know the momentary impact of a scheduling decision taken in one cell, on the interference level in surrounding cells. In the UL this factor is highly time-varying since the users change orientation and position quickly, thereby affecting antenna diagrams with respect to surrounding base station sites by tens of dBs—in a second.

This embodiment discloses new ways to compute the impact factors, by making full use of the neighbour cell interference estimators. The idea is to set up and solve a least squares or Kalman filtering problem on line, using quantities that are anyway made available by the estimators. As will be seen, this has a number of potential advantages.

No measurement resources are needed in the terminals. Note that continuous measurement of path-loss is needed by all terminals in the cell in case a direct measurement approach is taken. No additional Radio Resource Control (RRC) signalling is needed. As will be seen below, the needed information can be signalled per cell, with maximum 10 Hz, over Iub and possibly Iur. The quantities processed in the radio access node that performs the impact factor computations are already aggregated and subject to optimal filtering. This is a fact that is likely to enhance the accuracy and bandwidth of the impact factor tracking, as compared to the case where direct path-loss measurements are used. The implementation of the on-line least squares solution can be performed recursively with standard techniques of system identification. This allows for low computational complexity and good tracking properties. An alternative is to use Kalman filtering techniques.

Consider the cell i of a cellular network. Index the set of closest cells by {j(i)}. Applying the estimator proposed earlier then allows estimation of \hat{P}_{neighbor,i}(t| t) and {\hat{P}_{own,j(t}(t|t)}. Denoting the set of impact factors from the set of neighbour cells {j(i)} on the interference of cell i by {gⱼ₍ᵢ₎} the following equations can be written down:

$${\hat{P}}_{neighbor , i} ( {t}_{k} \vert {t}_{k} ) = {( {\hat{P}}_{own , {j}_{1} ( i )} ( {t}_{k} \vert {t}_{k} ) … {\hat{P}}_{own , {j}_{1} ( i )} ( {t}_{k} \vert {t}_{k} ) )}^{T} ( \begin{matrix}{g}_{{j}_{1} ( i )} \\ M \\ {g}_{{j}_{I} ( i )}\end{matrix} ) + {e}_{i} ( {t}_{k} ) , \\ k = 1 , … , \qquad ( C1 )$$

where I denotes the number of relevant neighbour cells of cell i, and where eᵢ(tₖ) is the momentary error. k is used to index the time instances when estimates are taken. It is clear from (C1) that in order to find the impact factors, at least I measurements of the neighbour cell interference need to be collected. Using 32 neighbours then requires 32 TTIs of measurements for this, which corresponds to about 64 ms. Therefore, even with the use of a factor of 10 excess measurements it follows that the impact factors could be tracked with a bandwidth of about 1 s with the proposed method. Accounting for the Iub BW limitation of 10 Hz, a tracking bandwidth corresponding to 1 s seems possible with 5 excess measurements.

In order to use (C1), it is proposed that a least squares or Kalman filter setting to solve (C1) is employed, then implementing the solution with standard algorithms. The complexity of the method is very low.

Impact factor calculations have been provided in prior art for the long term evolution (LTE) cellular air interface. However, all here presented aspects of soft, softer and remaining neighbour cell interference power are novel, as is the WCDMA estimation of neighbour cell interference.

1. A method for assisting in soft handover procedures in WCDMA time division schedules, comprising the steps of:
estimating, in a first NodeB, a high bandwidth neighbour cell interference power for each time division slot;
computing, in said first NodeB, a first change trend of said estimated high bandwidth neighbour cell interference power for each said time division slot;
predicting, in said first NodeB, a future incoming soft handover event of a UE from a neighbour NodeB to said first NodeB, and a future incoming soft handover time (tSHO) for said future incoming soft handover event, based on said first change trend of said estimated high bandwidth neighbour cell interference power; and
adapting, in said first NodeB, scheduling of time division slots of UEs before said predicted future incoming soft handover time (tSHO), creating interference power headroom for said predicted future incoming soft handover event.

2. The method according to claim 1, characterized in that said step of predicting comprises:
setting of a first interference threshold;
extrapolating said first change trend into the future;
predicting said future incoming soft handover event to occur if said extrapolated first change trend reaches said first interference threshold;
predicting said future incoming soft handover time (tSHO) as the time at which said extrapolated first change trend reaches said first interference threshold.

3. The method according to claim 1, characterized in that said predicted future incoming soft handover event is predicted to occur based on said estimated high bandwidth neighbour cell interference power in a particular first time division slot, wherein said step of scheduling comprises at least one of:
reducing grants to scheduled users of said particular first time division slot;
rescheduling scheduled users of said particular first time division slot to time division slots with more headroom; and
rescheduling scheduled users of said particular first time division slot to code division mode.

4. The method according to claim 1, characterized in that said step of estimating comprises:
obtaining of process measurements of a received total wideband power received in said first NodeB;
obtaining of process measurements of the uplink load utilization; and
performing a joint estimate of at least the sum of said neighbour cell interference power and a noise floor power.

5. The method according to claim 4, characterized in that said step of estimating comprises performing a joint estimate of said neighbour cell interference power and of said noise floor power.

6. The method according to claim 5, characterized in that said step of estimating is performed by one of Bayesian estimation algorithms and extended Kalman filtering in combination with a thermal noise power estimation scheme.

7. The method according to claim 1, characterized by the further steps of:
receiving, from neighbour cells, estimates of a respective neighbour cell interference power and estimates of a respective own controlled interference power of user equipments of each respective cell;
calculating, for each time division slot, an estimate of a coupling factor, describing the effect of scheduled traffic of one cell on interference power of neighbour cells;
deriving an estimate of a neighbour cell interference power impact from the own cell for each time division slot and each neighbour cell;
computing a second change trend of said estimated neighbour cell interference power impact from the own cell for each time division slot and each neighbour cell;
predicting a future outgoing soft handover event of a UE from said first NodeB to a neighbour NodeB, and a future outgoing soft handover time (tSHO″) for said future outgoing soft handover event, based on said second change trend of said estimated neighbour cell interference power impact from the own cell; and
adapting, in said first NodeB, scheduling of time division slots before said predicted future outgoing soft handover time (tSHO″), creating interference power headroom for said predicted future outgoing soft handover event.

8. The method according to claim 7, characterized in that said step of predicting a future outgoing soft handover event comprises:
setting of a second interference threshold;
extrapolating said second change trend into the future;
predicting said future outgoing soft handover event to occur if said extrapolated second change trend reaches said second interference threshold; and
predicting said future outgoing soft handover time (tSHO″) as the time at which said extrapolated second change trend reaches said second interference threshold.

9. The method according to claim 7, characterized in that said predicted future outgoing soft handover event is predicted to occur based on said estimated high bandwidth neighbour cell interference power in a particular second time division slot, wherein said step of scheduling comprises at least one of:
reducing grants to the scheduled user creating the interference impact in the neighbour cell;
rescheduling the scheduled user creating the interference impact in the neighbour cell to time division slots where the experienced neighbour cell interference is low; and
rescheduling the scheduled user creating the interference impact in the neighbour cell to code division mode.

10. The method according to claim 7, characterized by the further step of determining from which neighbour cell said predicted future incoming soft handover event is predicted to occur, wherein said step of scheduling comprises:
calculating relative grants for the neighbour cell from which said predicted future incoming soft handover event is predicted to occur, for adapting a transmitting power of a user equipment of said predicted future incoming soft handover event to a tolerable level for existing users in the cell of the first NodeB; and
sending said relative grants to said neighbour cell from which said predicted future incoming soft handover event is predicted to occur.

11. A NodeB in a WCDMA communication system, comprising:
a scheduler for WCDMA time division;
an interference estimator configured to estimate a high bandwidth neighbour cell interference power for each time division slot;
a trend follower, connected to said interference estimator, said trend follower being configured for computing a first change trend of said estimated high bandwidth neighbour cell interference power for each said time division slot; and
a predictor, connected to said trend follower, said predictor being configured for predicting a future incoming soft handover event of a UE from a neighbour NodeB to said first NodeB, and a future incoming soft handover time (tSHO) for said future incoming soft handover event, based on said first change trend of said estimated high bandwidth neighbour cell interference power;
wherein said scheduler being connected to said predictor and being configured for adapting scheduling of time division slots before said predicted future incoming soft handover time (tSHO), creating interference power headroom for said predicted future incoming soft handover event.

12. The NodeB according to claim 11, characterized in that said predictor is configured for:
setting of a first interference threshold;
extrapolating said first change trend into the future;
predicting said future incoming soft handover event to occur if said extrapolated first change trend reaches said first interference threshold;
predicting said future incoming soft handover time (tSHO) as the time at which said extrapolated first change trend reaches said first interference threshold.

13. The NodeB according to claim 11, characterized in that said predicted future incoming soft handover event is predicted to occur based on said estimated high bandwidth neighbour cell interference power in a particular first time division slot, wherein said scheduler is configured for at least one of:
reducing grants to scheduled users of said particular first time division slot;
rescheduling scheduled users of said particular first time division slot to time division slots with more headroom; and
rescheduling scheduled users of said particular first time division slot to code division mode.

14. The NodeB according to claim 11, characterized in that said interference estimator is configured for:
obtaining of process measurements of a received total wideband power received in said first NodeB;
obtaining of process measurements of the uplink load utilization; and
performing a joint estimate of at least the sum of said neighbour cell interference power and a noise floor power.

15. The NodeB according to claim 14, characterized in that said interference estimator is configured for performing a joint estimate of said neighbour cell interference power and of said noise floor power.

16. The NodeB according to claim 15, characterized in that said interference estimator is configured for performing estimation by one of Bayesian estimation algorithms and extended Kalman filtering in combination with a thermal noise power estimation scheme.

17. The NodeB according to claim 11, characterized by further comprising:
a receiver, connected to said interference estimator, said receiver being configured for receiving estimates of a respective neighbour cell interference power and estimates of a respective own controlled interference power of user equipments of each respective cell;
wherein said interference estimator being further configured for calculating, for each time division slot, an estimate of a coupling factor, describing the effect of scheduled traffic of one cell on interference power of neighbour cells;
wherein said interference estimator being further configured for deriving an estimate of a neighbour cell interference power impact from the own cell for each time division slot and each neighbour cell;
wherein said trend follower being further configured for computing a second change trend of said estimated neighbour cell interference power impact from the own cell for each time division slot and each neighbour cell;
wherein said predictor being further configured for predicting a future outgoing soft handover event of a UE from said first NodeB to a neighbour NodeB, and a future outgoing soft handover time (tSHO″) for said future outgoing soft handover event, based on said second change trend of said estimated neighbour cell interference power impact from the own cell;
wherein said scheduler being further configured for adapting scheduling of time division slots before said predicted future outgoing soft handover time (tSHO″), creating interference power headroom for said predicted future outgoing soft handover event.

18. The NodeB according to claim 17, characterized in that said predictor being configured for:
setting of a second interference threshold;
extrapolating said second change trend into the future;
predicting said future outgoing soft handover event to occur if said extrapolated second change trend reaches said second interference threshold; and
predicting said future outgoing soft handover time as the time (tSHO″) at which said extrapolated second change trend reaches said second interference threshold.

19. The NodeB according to claim 17, characterized in that said predicted future outgoing soft handover event is predicted to occur based on said estimated high bandwidth neighbour cell interference power in a particular second time division slot, wherein scheduler is configured for at least one of:
reducing grants to the scheduled user creating the interference impact in the neighbour cell;
rescheduling the scheduled user creating the interference impact in the neighbour cell to time division slots where the experienced neighbour cell interference is low; and
rescheduling the scheduled user creating the interference impact in the neighbour cell to code division mode.

20. The NodeB according to claim 17, characterized by a transmitter, connected to said scheduler, and in that said predictor is further configured for determining from which neighbour cell said predicted future incoming soft handover event is predicted to occur, wherein said scheduler being further configured for:
calculating relative grants for the neighbour cell from which said predicted future incoming soft handover event is predicted to occur, for adapting a transmitting power of a user equipment of said predicted future incoming soft handover event to a tolerable level for existing users in the cell of the first NodeB; and
said transmitter being configured for sending said relative grants to said neighbour cell from which said predicted future incoming soft handover event is predicted to occur.
